(19) United States
(12) Patent Application Publication
(10) Pub. No.: US 2005/0114658 A1
(43) Pub. Date: May 26, 2005

(54) Remote web site security system

(76) Inventors: Matthew J. Dye, Palermo, NJ (US); Terrence J. Kepner, Somers Point, NJ (US); Ernest N.S. Ostro, Holden, MA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 10/717,734

(22) Filed: Nov. 20, 2003

(51) Int. Cl. G06F 12/14; H04L 9/00

(52) U.S. Cl. 713/165; 713/201; 707/9

(57) ABSTRACT

The invention is a method for monitoring a file in a file security system, including providing a first file representation of a file in which the file is disposed at a first location and first processing the first file representation to provide first signals in accordance with the first file representation. The first signals are stored in a central repository disposed at a second location wherein the second location is remote from the first location. A second file representation of the file is provided wherein the file is disposed at a third location remote from the second location. Second processing of the second file representation is performed to provide second signals in accordance with the second file representation. The first signals are accessed from the central repository and the first signals are compared with the second signals. A status of the file is determined in accordance with the comparing.

### BACKGROUND OF THE INVENTION

1. FIELD OF INVENTION

This invention relates to the field of web site and file security and, in particular, to the field of providing such web site and file security by monitoring the web site or file from a remote location.

2. Description of Related Art

U.S. Pat. No. 5,136,647, entitled “Method for Secure Time-Stamping of Digital Documents,” issued to Haber et al., discloses a system for time-stamping a digital document that protects the secrecy of the document text and provides a tamper-proof time seal establishing an author's claim to the temporal existence of the document. The document is reduced to a number using a one-way hash function to fix a unique representation thereof. The number can be transmitted to an outside agency where the current time is added to form a receipt which is certified by the agency using a public key signature procedure before being returned to the author as evidence of the document's existence.

In later proof of such existence, the certificate is authenticated using the agency's public key to reveal the receipt which comprises the hash of the alleged document along with the time seal that only the agency could have signed into the certificate. The alleged document is then hashed with the same one-way function and the original and newly-generated hash numbers are compared. A match establishes the document identity. A plurality of agencies can be designated using random selection based upon a unique seed that is a function of the hash number of the document to be time-stamped.

U.S. Pat. No. 5,475,625 entitled “Method and Arrangement for Monitoring Computer Manipulations,” issued to Glaschick, teaches a method for monitoring manipulations on computers which are connected via a network wherein attributes are obtained automatically from data bases and compared with reference values of the attributes. An alarm is triggered in the event of non-correspondence.

U.S. Pat. No. 5,621,889 entitled “Facility for Detecting Intruders and Suspect Callers In a Computer Installation and a Security System Including Such a Facility,” issued to Lermuzeaux, et al., discloses use of surveillance data relating to the operation of an installation for detecting intrusions. The facility includes elements for modeling the computer installation, its users and their respective behavior with the help of a systemic network, elements for comparing the modelized behavior of the system and of its users relative to modelized normal behavior, and elements for interpreting observed intrusion hypothesis and intrusions in order to indicate them and enable restraint actions to be prepared.

U.S. Pat. No. 5,991,881 entitled “Network Surveillance System,” issued to Conghlin, et al., teaches a system and method for network surveillance and detection (Beginning of Side 2) into the work and into computers connected to the network. The system functions are: (a) intrusion detection monitoring; (b) real time alert; (c) logging of potential unauthorized activity; and (d) incident progress analysis and reporting. Upon detection of any attempts to intrude the system initiates a log of all activity between the computer elements involved and sends an alert to a monitoring console.

U.S. Pat. No. 6,018,801 entitled “Method For Authenticating Computer Documents On a Computer Network,” issued to Palage, et al., discloses a method for verifying a source of an electronic document located on a computer network, wherein the document is viewed through a document viewer, which includes incorporating a document identifier into the electronic document. The document identifier contains identifying information related to the electronic document. A verification signal containing the identifying information and location information related to the location of the electronic documents on the computer network is generated with the document viewer and is transmitted to a verification computer. The verification computer accesses a data source to retrieve an identification record and a location record for the electronic document. These records are compared with the verification signal, and a reply signal is generated and transmitted back to the document viewer. If the information in the verification signal does not match the information contained in the information and location records, then an error message may be generated which is sent to a designated recipient as notification of the error.

U.S. Pat. No. 6,029,245 entitled “Dynamic Assignment of Security Parameters to Web Pages,” issued to Scanlin, discloses a method for dynamically assigning security parameters to HTML pages of an information provider on the worldwide web whereby one set of HTML pages need be stored and maintained for retrieval by client computers using differing security protocols. A security injection profile is provided for storing security parameters for each respective security protocol.

U.S. Pat. No. 6,298,445 entitled “Computer Security,” issued to Shostac, et al., teaches automatically providing enhancement to computer security software whenever the enhancements become available. The invention relates to an integrated system for assessing security vulnerabilities of a computer and/or a computer network.

U.S. Pat. No. 6,477,651, entitled “Intrusion Detection System and Method Having Dynamically Loaded Signatures,” issued to Teal, teaches an intrusion detection system for detecting unauthorized or malicious use of network resources including an intrusion detection analysis engine that detects signatures associated with attacks on network vulnerabilities. As new network vulnerabilities are identified, new analysis objects can by dynamically interfaced on a one time basis with the intrusion detection analysis engine to detect signatures associated with the new network vulnerabilities.

U.S. Pat. No. 6,532,463, entitled “Web Page Accessing of Databases and Main Frames,” issued to Robins, et al., teaches a method of providing web access to data using dynamic generation of web pages by a main frame connected to a web server.

U.S. Pat. No. 6,560,639, entitled “System For Web Content Management Based on Server Side Application,” issued to Dan, et al., discloses a web management system including a data base having a directory structure associating each web page of a web site with attributes thereof. The web site management system may include a web server for displaying each web page, and a server side front end daemon communicable with the web server and the data base. The front end daemon may identify the attributes of any user changed web page and store the attributes of any user changed web page in that data base. The identifying and/or the storing may be automatic or user initiated. The system may include a file a file system caching all web pages in a web site. The web pages so cached may be static.

U.S. Pat. No. 6,567,918, entitled “Saved Web Page Security System and Method,” issued to Flynn, et al. teaches a system and method of saving a web page from a web site on an internet to a computer readable medium. A web page is downloaded from the internet to the computer readable medium. The internet address for the web page is stored on the computer readable medium. When the web page is opened from the computer readable medium, the internet address is used to identify a security context for the web page. By using the internet address to identify the security context for the web page, the system taught by Flynn, et al. allows users to securely view and execute web pages downloaded from the internet.

U.S. Pat. No. 6,594,662, entitled “Method and System for Gathering Information Resident on Global Computer Networks,” issued to Sieffert, discloses a method for analyzing a set of network resources over a configurable monitoring period, thereby guaranteeing that recently published information is retrieved. At the end of each monitoring period the traversal and searching of network resources across the computing devices in the distributed system according to the previous number of pages retrieved for each network resource is balanced, thereby more accurately balancing the system.

U.S. Pat. No. 6,611,870, entitled “Information Search Method and System for Registering and Searching for Associated Multi-Media Data Using Embedded Information,” issued to Shinoda, et al., discloses a mark management server which embeds a mark ID in a mark image in response to mark request from a www server and registers information related to a web page corresponding to the mark ID in a mark management database.

U.S. Pat. No. 6,658,569, entitled “System for Determining Web Application Vulnerabilities,” issued to Reshef, et al., discloses a method for detecting security vulnerabilities in a web application including analyzing the client requests and server responses resulting therefrom in order to discover the predefined elements of the application's interface with external clients and the attributes of these elements. The client requests are then mutated based on a predefined set of mutation rules to thereby generate exploits unique to the application. The web application is attacked using the exploits and the results of the attack are evaluated for application activity.

U.S. 2001/0034847, entitled “Internet/Network Security Method and System for Checking Security of a Client From a Remote Facility,” filed by Gaul, discloses a method for network security systems which is suited for finding vulnerabilities to computer hacking and unauthorized entry. An application of the network security system method and apparatus taught by Gaul is disclosed for either an internet bay system or an internal computer network system.

U.S. 2002/0099959, entitled “Davis Security System and Method Responsive to Electronic Attacks,” filed by Redlich, et al., discloses a method for securing data against a plurality of electronic and environmental events directed at computers utilizing a hacking monitor which generates attack warnings, such as a hacking warning, dependent upon the severity of the attack. Based upon these warnings, data is filtered to extract security sensitive words and the extract and the remainder data, if necessary, is stored in assigned memory. Full or partial reconstruction is permitted, manually or automatically, with a security clearance. The information processing system includes a filter which is adjusted based upon the degree of attack warning to extract security sensitive words.

U.S. 2002/01040123, entitled “System and Method for Using Dynamic Web Components to Remotely Control a Security State of Web Pages,” by Hewett, et al., discloses a method for controlling whether a displayed web page and associated frames displayed within a window of a web page are secured or non-secured. For example, whether the disclosed web page and the associated frames are provided via a secure socket layer or simply via HTTP address, respectively.

U.S. 2002/0112162 discloses authentication and verification of the integrity of multi-media content delivered from a server to a client through a computer network, such as the internet to reduce the possibility of inaccurate and/or unintended content being displayed by a user. Each content file stored on the server is cryptographically registered and such registration information is stored on the server along with the corresponding name. A user is provided with a second, public, key corresponding to a first, private, key used to cryptographically register the content files.

U.S. 2002/0129273, entitled “Secure Content Server Apparatus,” filed by Noonan, discloses a system wherein write access is prevented whereby a number of content substitution security exposure such as web site defacing are avoided. In this method, web pages or web documents to be served cannot be overwritten with alternative content by hacking into a server device.

EP 1,128,628 entitled, “Method and Apparatus for Internet Web Site Authentication,” issued to Hawkes, et al., teaches a method for authentication an internet web site, wherein the web site is verified each time it is accessed by a user browser. Upon receipt of a page request, the web site generates a web page into which is embedded an unique identifier. A JAVA applet for execution of the verification process may also be embedded or may be resident on the user browser. At the user end, the browser initiates the applet and extracts the unique identifier which is set, together with browser and web site location date to a verification server. The server performs a look up comparing the unique identifier and its address with a record of the correct identifier and address.

All references cited herein are incorporated herein by reference in their entireties.

### BRIEF SUMMARY OF THE INVENTION

The invention provides periodic monitoring of a file combined with legal proof of content timestamps. Also provided is a combination of monitoring of a complete web site (i.e. every single page or source file) and legal proof of content timestamps of each file's contents.

Using a server-based piece of software (agent) for scanning that is tied to a central service the system of the invention monitors a heartbeat for the agent and alerts the user when the agent has not recorded a heartbeat in a predetermined amount of time and allows for central configuration and logging of the agent's activity. Furthermore, the system stores file information (or other relevant information) locally on the user's machine or centrally according to the configuration of the agent. Communication with the agent can be via XML transactions over HTTPS and is self-updating from the central service. A combination of RSA public/private key pairs and Kerberos can be used to authenticate communication in both directions (the agent to the service and the service to the agent). Periodic site-spidering (SiteScans) can be used to automatically detect new files on a web site in combination with a site-monitoring service and changed files are stored for evidentiary uses and online comparison of evidence file with good copy.

A user of the system of the present invention creates an account on web site security system of the invention. The system as its own Certificate Authority issues the user a unique Digital Certificate that incorporates some of the user's registration information. The user stores alert contact information and, if using SourceScan or AutoRestore, supplies login credentials for their server. The user registers web pages and/or source code files to their account. The files can be added manually one by one or the security system can launch a spider that will automatically crawl over the user's site to discover and add the available files (SiteScan). The user can assign certain settings to the file(s) added, e.g. the scan interval.

During the file registration, a set of unique digital signatures of the file are generated. These are combined with the user's digital certificate, a security system digital certificate, a pass-phrase and a timestamp into a unique digital signature. The signatures are stored in the system's databases. Once the file is activated for scanning, The security system will return to the user's site on a set interval of the user's choosing, download the file, regenerate one or more of the file's unique signatures and compare them to the signatures in the system database for that file. If the signatures do not match (status red), if the file has been moved, deleted or its permissions changed such that the file is inaccessible to the security system (status orange), or if the user's server is unavailable because it is offline etc (status purple), an incident is generated and the user is notified using the contact method associated with the file.

The security system can monitor files in one of three ways: a) Using HTTP or HTTPS to download a web page in the same way that a typical user would with a web browser. This means that the security system sees the end result of any dynamic pages that are generated by scripts on the user's web server; a) using FTP to log in to a user's server and download the files (SourceScan). In this case, the system can monitor the source code/scripts used to generate dynamic sites; b) using a system OnSite. This is a software program installed on the user's server which monitors file's locally and communicates with the security system central servers to exchange signatures, configuration settings, heartbeats, etc. This cuts the amount of traffic between the user's servers and security system. When a file is legitimately changed the user can tell the security system to re-scan the file and update the database with the new signatures that reflect the new file contents and the new timestamp.

The security system provides four methods for user's to interact with the system: a) using the security system web site, users can login to the site and have full control over all their file settings; b) XML—users can post XML transactions using XML-RPC over HTTPS to the security system and perform a full range of file functions (update a file, edit settings, activate/deactivate a file etc); c) Email—users can respond to event alerts with a limited set of email instructions; or d) Local Configuration—available for the security system OnSite only (in development).

In the present invention changes in web pages can be detected by comparing mathematical signatures or by comparing the entire file. Furthermore, users can exclude content not to be considered using tags, e.g., (webguard_ignore). The final output of a process that combines files, programming and information from other sources such a databases, for instance a dynamic web page, can be monitored. Such databases can be disposed within another database or can be in the form of a table within a database. Additionally, a physical file store to disk can be monitored. The scan can be initiated on a schedule, continuously, or in response to a system event (such as a file being written to disk, a log in or a log out). The scan can also be initiated by a customer request through an on line interface with the security system by standard supported transaction (such as XML) requests, or by an interface to customer or third party software using a software developers kit. The initiation can be manual or automated and can be performed at the time the file is requested for viewing, by an extension of the software that provides the file to the viewer, e.g., a module built into a web server that checks a web page before sending it to the user. A file can be accessed remotely using standard transport protocols such as HTTP, HTTPS, FTP through a file system and its extensions such as NFS, NTFS Windows Sharing, or it can be delivered to the security system through a transport protocol such as SMTP or HTTP.

When a change to a file is detected the system of the present invention can send one or more alerts to email addresses, pagers, phone, etc. Alerts can escalate along a scripted path. The changed file can be restored from a copy in the central repository. Furthermore, all distinct variations of the changed file can be stored for later comparison or evidentiary purposes either on the customer machine or in the central remote repository. A customized response library can also be provided.

The remote repository can include one or more of: storage of complete copy or file, storage of different authorized versions of a file as a file is changed, storage of unauthorized changes to a file, storage of information relating to a file such as scanned times, scanned history, alerts, remote location of file on customer server, URL of file, storage of file signatures or storage timestamps. A scan can be initiated from a central service that accesses the customer's computer from a remote location, from the customer's server itself or from a customer server that monitors several other customer servers.

The system of the present invention can also include a method for validating authorized changes to a file versus unauthorized changes. Authorized administrators of a customer's file can interact with the security system to inform the security system of genuine changes to a file. Before the system notices a change the user has the ability to schedule a file change for a future time or date. Also, before the system notices a change the administrator can notify the system of an immediate or current change. In response to an alert event there are methods for transacting a changed notification directly through the security system administrative interface. Agreed upon message formats (such as, for example, an XML DDT specification or keyword responses to an email alert) over a transmission protocol (such as HTTP, HTTPS, or SMTP) can be used. Initiation of the message can be by manual action, a timed automated event, a process built into customer software, an automated response to a system event, or a security system alert.

The invention also includes a method for scanning a file location or web site and matching the URL address of a file to a physical file name/location in a file system for a web site. In this case, starting at a single point on the web site with a known file system location an automated spider can find all other referenced files in the webs site and determines their file system location and file name by reference to the starting file. In the case of a file system, starting at a single directory with a known URL, the file system is traversed to find all other files and determine their URL by reference to the starting file. The list of files processed can be controlled by an exclusion or inclusion list on a web site, directory, file name (including file extension) basis. An authentication engine for creating and providing digital signals and certificates can be used to modify and verify files for changes.

The invention is a method for monitoring a file in a file security system, which includes the steps of providing a first file representation of a file in which the file is disposed at a first location and first processing the first file representation to provide first signals in accordance with the first file representation. The first signals are stored in a central repository disposed at a second location wherein the second location is remote from the first location. A second file representation of the file is provided wherein the file is disposed at a third location remote from the second location. Second processing of the second file representation is performed to provide second signals in accordance with the second file representation. The first signals are accessed from the central repository and the first signals are compared with the second signals. A status of the file is determined in accordance with the comparing. The invention also involves a method for monitoring a file in the file security system, wherein the first location is substantially the same as the third location, and the first and second processing steps include the further step of applying a hash function to the first and second file representations. Additionally, the invention includes a method for monitoring a file in a file security system, which provides corresponding first and second mathematical signatures of the first and second file representations in accordance with the hash functions in addition to the step of comparing the first and second mathematical signatures.

The invention is also a method for monitoring a file in a file security system, which includes the following steps: (a) providing a number of files disposed at various locations, each file having a respective location indicator for indicating the location where the file is disposed and a respective first file representation; (b) first processing each first file representation to provide a corresponding number of first signals in accordance with the first file representations; (c) storing the first signals and respective location indicators in a central repository disposed in a location remote from the differing locations; (d) providing a second file representation of a selected file having a selected location indicator; (e) second processing the second file representation to provide second signals in accordance with the second file representation; (f) accessing selected first signals of from the central repository in accordance with the selected location indicator; and (g) comparing selected first signals with second signals. The invention further includes a method for monitoring a file in a file security system additionally involving the steps of determining a status of the selected file in accordance with the comparing, wherein the first and second processing comprise the further step of applying a hash function to the first and second file representations. In addition, this method includes the further step of providing corresponding first and second mathematical signatures of the first and second file representations in accordance with the hash function and comparing the first and second mathematical signatures.

The invention is also a method for monitoring a file in a file security system, which includes the following steps: (a) providing a file to be monitored; (b) applying several hash functions to the file to provide for a number of file signatures; (c) applying a time varying stamp to at least one of the file signatures to provide a time stamped file signature; (d) combining the file signatures including the time stamped file signature in order to provide a combined file signature; (e) applying a hash function to the combined file signature to provide a hashed file signature; and (f) comparing the hashed file signature with a further file signature. The invention further includes a method for monitoring a web page in a web security system in which the hash functions include the SHAH-1, MD2 and MD5 hash functions. Additionally, the method involves the further steps of interspersing the file signatures with random characters to form a number of file signatures having a predetermined length, changing the time varying stamp on a daily basis, and storing the time varying stamps for use in subsequent comparisons of the file signature with differing file signatures.

The invention is also a method for monitoring a file in a file security system, including the steps of providing a first file representation of a file wherein the file is disposed at a first location and first processing the first file representation to provide first signals in accordance with the first file representation. The first signals are stored in a central repository disposed at a second location wherein the second location is remote from the first location;

### BRIEF DESCRIPTION OF SEVERAL VIEWS OF THE DRAWINGS

The invention will be described in conjunction with the following drawings in which like reference numerals designate like elements and wherein:

FIG. 1 shows a block diagram representation of a remote site monitoring administrative overview of the web site security system of the present invention.

FIG. 2 shows a block diagram representation of a process overview of the web site security system of the present invention.

FIG. 3 shows a block diagram representation of a file registration process overview suitable for use with the web site security system of the present invention.

FIG. 4 shows a block diagram representation of the HTTP/HTTPS file retrieval within the web site security system of the present invention.

FIG. 5 shows a block diagram representation of the FTP file retrieval within the web site security system of the present invention.

FIG. 6 shows a block diagram representation of the file signature process suitable for use within the web site security system of the present invention.

FIG. 7 shows a block diagram representation of the file storage within the web site security system of the present invention.

FIG. 8 shows a block diagram representation of the HTTP/HTTPS file scan launcher of the web site security system of the present invention.

FIG. 9 shows the FTP file scan launcher suitable for use within the web site security system of the present invention.

FIG. 10 shows a block diagram representation of the file scan process within the web site security system of the present invention.

FIG. 11 shows a textual representation of a method for determining the next file scan time within the web site security system of the present invention.

FIG. 12 shows a block diagram representation of the event handler within the web site security system of the present invention.

FIG. 13 shows a block diagram representation of the notification handler within the web site security system of the present invention.

FIG. 14 shows a block diagram representation of the AutoRestore within the web site security system of the present invention.

FIG. 15 shows a block diagram representation of the SiteScan launcher within the web site security system of the present invention.

FIG. 16 shows a block diagram representation of the HTTP/HTTPS SiteScan within the web site security system of the present invention.

FIG. 17 shows a block diagram representation of an algorithm for processing a file to extract URLs within the web site security system of the present invention.

FIG. 18 shows a block diagram representation of the FTP SiteScan within the web site security system of the present invention.

FIG. 19 shows a block diagram of the scan log compression within the web site security system of the present invention.

FIG. 20 shows a block diagram of the representation of the file base-time assignment within the web site security system of the present invention.

FIG. 21 shows a block diagram of the representation of the XML bridge within the web site security system of the present invention.

FIG. 22 shows a textual representation of the file explorer of the web site security system of the present invention.

FIG. 23 shows a block diagram representation of the OnSite architecture of the web site security system of the present invention.

FIG. 24 shows a block diagram representation of the OnSite file scheduling within the web site security system of the present invention.

FIG. 25 shows a block diagram of the OnSite file scanning within the web site security system of the present invention.

FIG. 26 shows a block diagram representation of the OnSite file communication within the web site security system of the present invention.

FIG. 27 shows a block diagram representation of the OnSite file administrative transactions within the web site security system of the present invention.

FIG. 28 shows a block diagram representation of the OnSite heartbeat transactions of the web site security system of the present invention.

FIG. 29 shows a block diagram representation of the OnSite local file repository integrity check transactions of the web site security system of the present invention.

FIG. 30 shows a block diagram representation of the OnSite ServerGuard within the web site security system of the present invention.

### DETAILED DESCRIPTION OF THE INVENTION

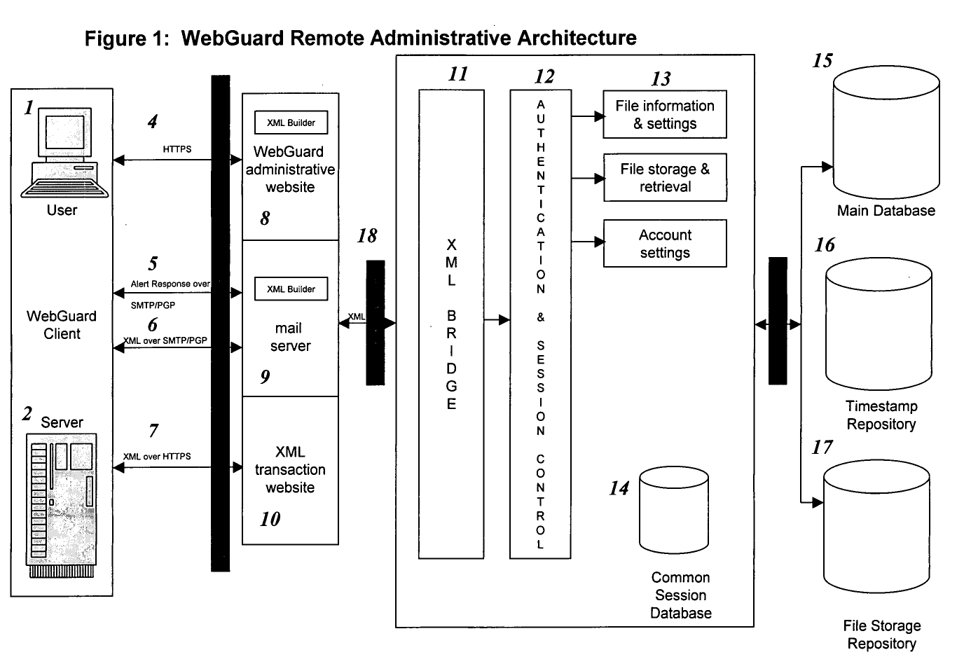

Referring now to FIG. 1, there is shown a remote site monitoring administrative overview of the file security system (20). The file security system (20) supports several different methods of administrative access and control. First, the file security system (20) administrative web site (8) can be accessed manually by a (1) over HTTPS (4) using a computer from any remote place with an internet connection. Second, XML transactions can be sent over SMTP (6) using PGP encryption to an email server (9) or over HTTPS (7) to an XML transaction site (10). Support for any of other additional encryption schemes other than PGP is included within the scope of the invention. The XML transactions can be sent manually by the file security system (20) customer (1) or automatically by an automatic process from the file security system (20) customer's server (2). Third, responses to the file security system (20) alerts can be sent over SMTP (5) to an email server (9) using keywords to initiate administrative actions. The file security system (20) operates upon and thereby provides security for protecting files where files are understood to include the product of programs that combine multiple files or any other assembly of data or information that may be located either within a web site or outside a web site. Furthermore, it will be understood that the foregoing administrative access or control can be performed using any pre-agreed protocol over any pre-agreed transport.

All of the file security system (20) customer-facing systems (8,9,10) in turn communicate with the core systems using XML transactions (18) sent through an XML bridge (11). The bridge (11) validates the structure of the XML, performs the necessary authentication (12), executes the transactions (13) against the necessary repositories (15,16,17), and encodes the resulting messages for return to the originating system.

The file security system (20) maintains four distinct repositories of information, one short-term and three long-term. This includes a common short-term session database (14), a database of customer and file settings (15), a database of registered timestamp signatures (16), and a repository of customer files (17). Files stored in the repository (17) stores are (de)-encrypted and (de)-compressed as they are deposited (written) or accessed (read).

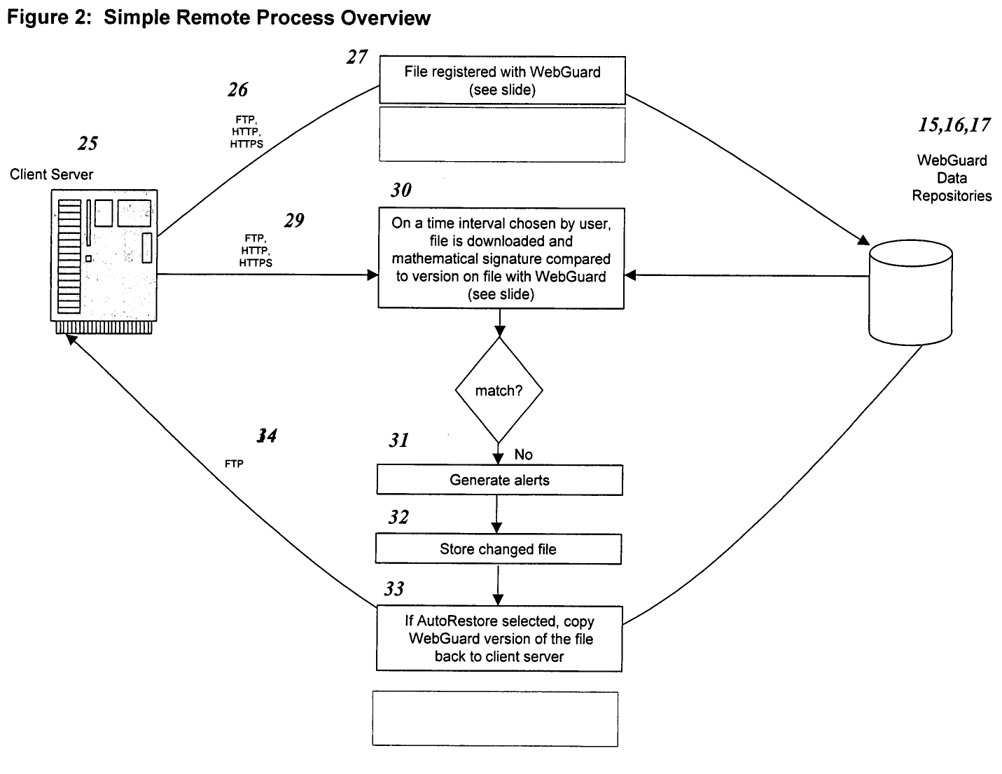

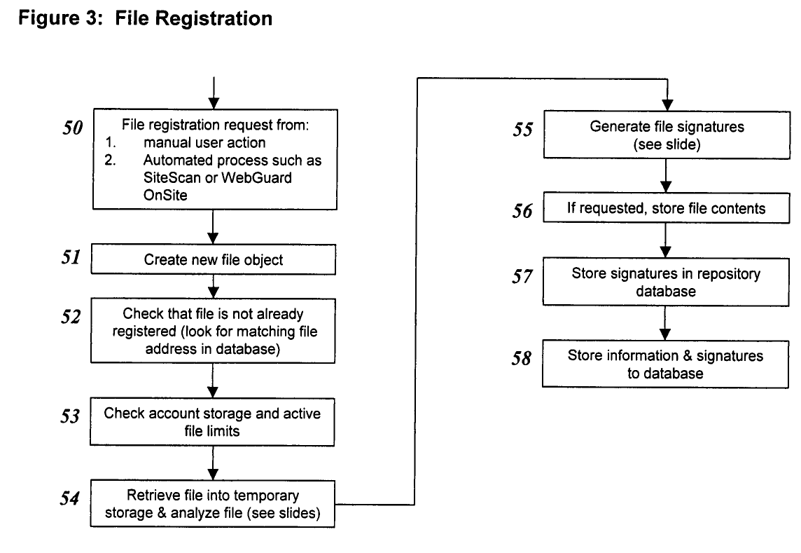

Referring now to FIG. 2, there is shown a process overview of the file security system (20). When a file is registered with the file security system (20) for Remote monitoring (27), the file is accessed from the customer's server (25) via FTP, HTTP, or HTTPS (26), is put through the registration procedure (described in more detail below with reference to FIG. 3) and the resulting information is stored in the file security system (20) repositories (15,16,17). Support for additional transport protocols known to those skilled in the art is included within the scope of the invention.

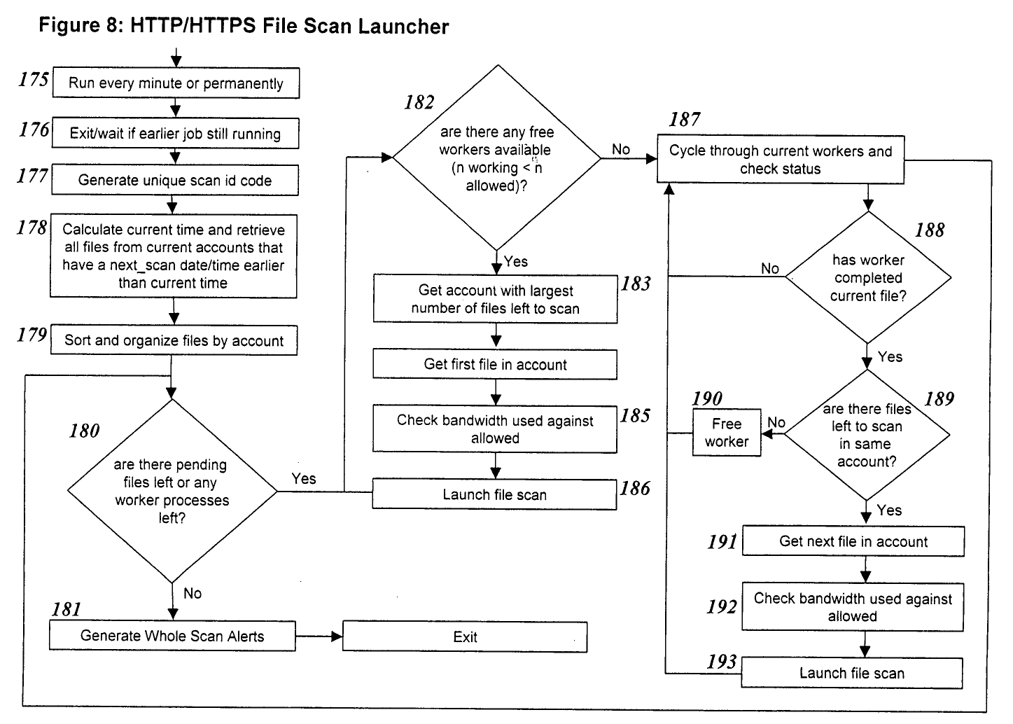

On a time interval of the customer's choosing (described in more detail below with reference to FIGS. 8, 9, 11), the monitored file is accessed from the customer's server (25) using the same transportation protocol (29) as used to register the file. The new copy's signatures are compared to the original (30). If the signatures do not match, an alert is generated (31) and the copy is stored for evidentiary purposes (32). If AutoRestore is enabled for the file (33), the file is copied from the file security system (20) repositories (15,16,17) back to the customer's server (25) using FTP (34), overwriting the changed file. Support for additional methods of accessing the customer's computer for AutoRestore known to those skilled in the art is included within the scope of the invention.

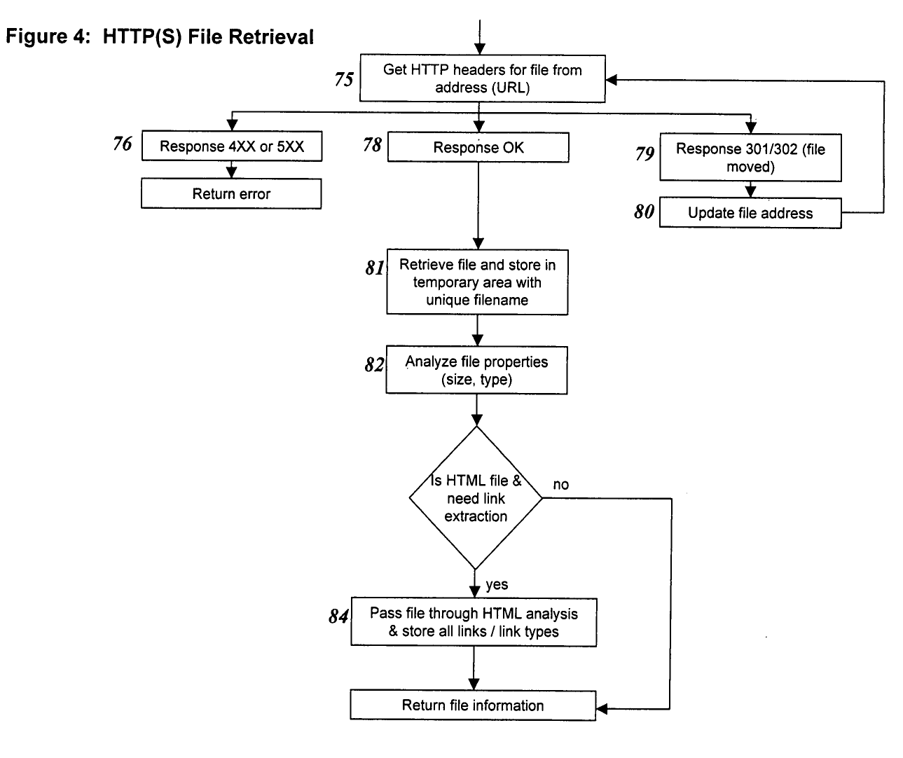

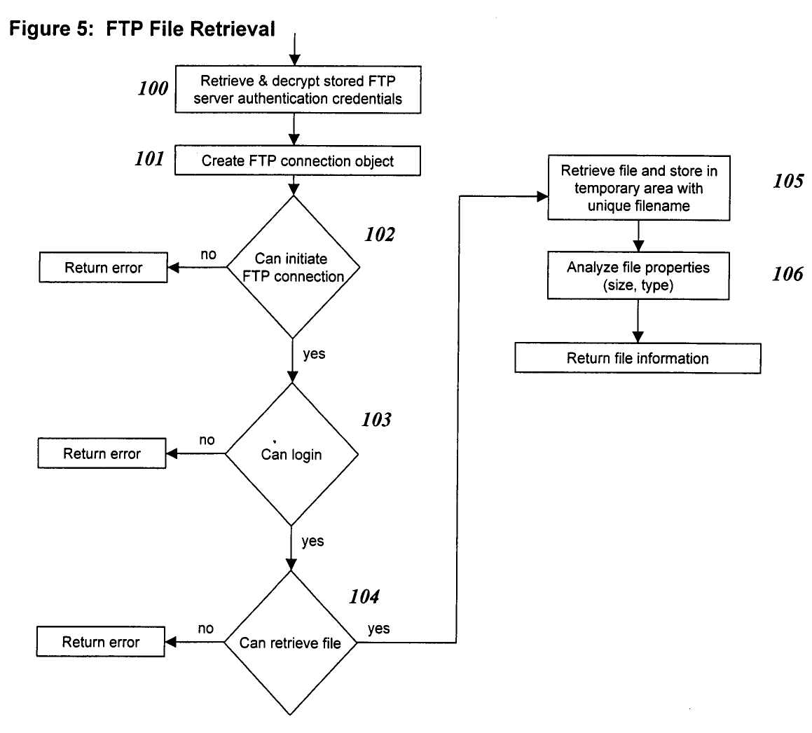

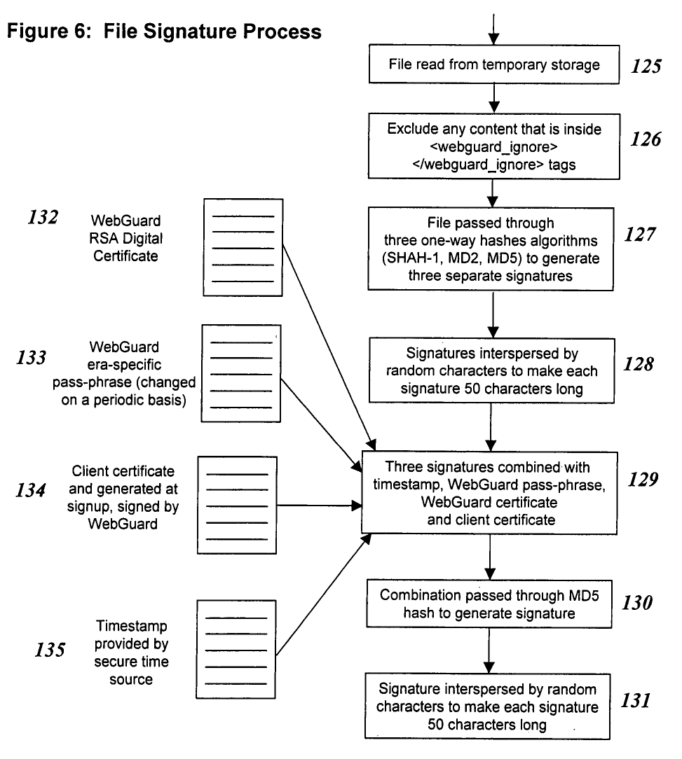

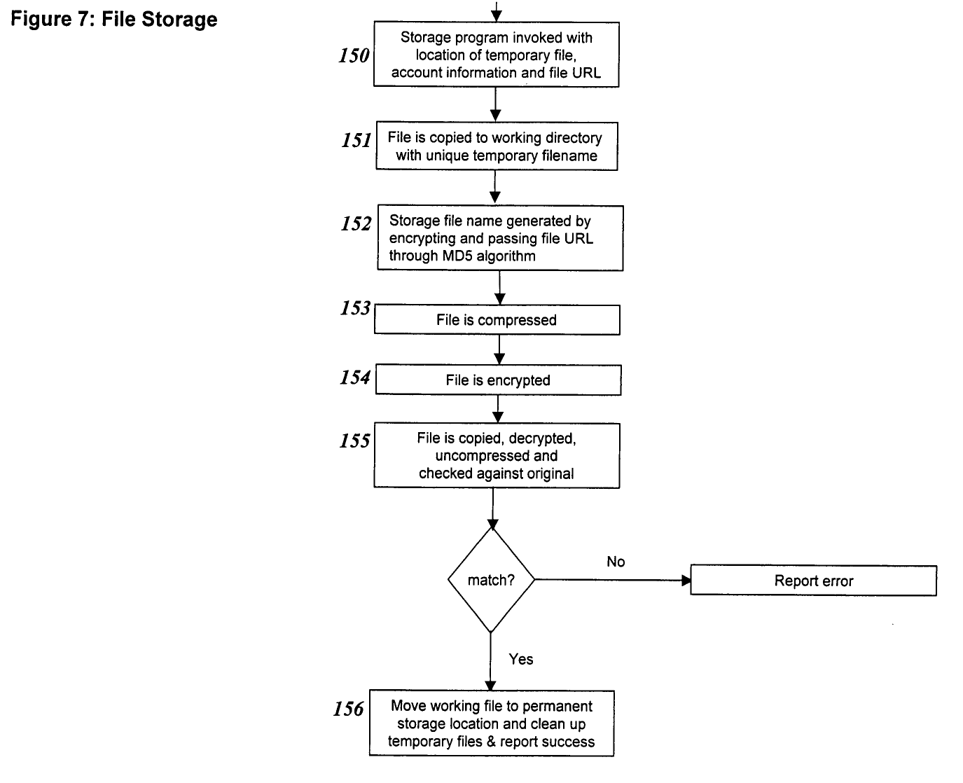

Referring now to FIG. 3, there is shown a file registration process overview. A file registration request (50) can be initiated from manual user action on the file security system (20) administrative web site (8) or by an automated process such as a site scan or the file security system (20) OnSite. The file security system (20) base file classes are loaded and a new file object is created (51). The system checks the address of the file in new request against the existing repositories (15,16,17) for uniqueness (52). The customer's account limits are also checked to make sure that there is enough space and active file slots left for the file (53). The file is retrieved from the customer's server (FIGS. 4, 5) and analyzed (54) and file signatures (55) are generated (FIG. 6). The file itself (56), the file signatures (57) and file information (58) are stored (FIG. 7) to the appropriate the file security system (20) data repositories (15,16,17).

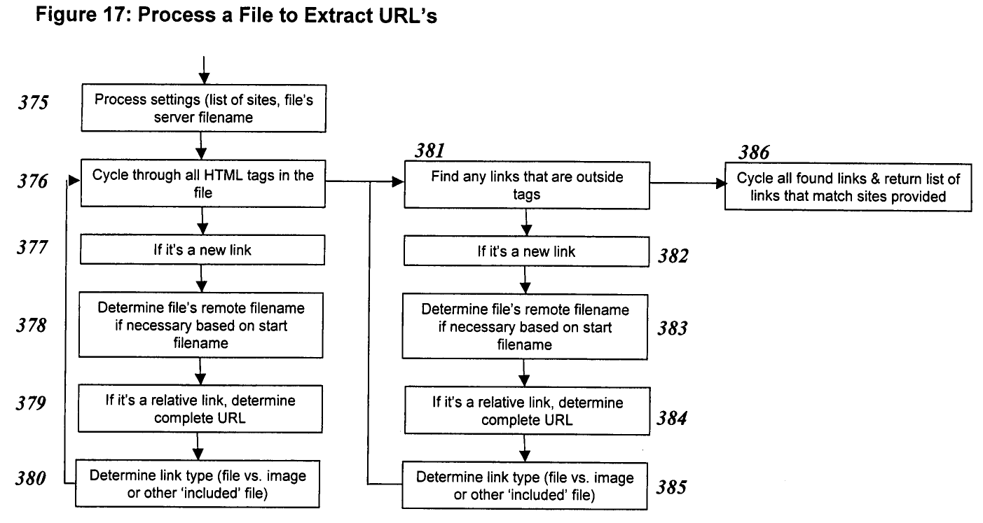

Referring now to FIG. 4, there is shown HTTP/HTTPS file retrieval. When a request for an HTTP or HTTPS file is initiated, the file security system (20) first retrieves the standard HTTP headers (75) for the file from the customer's server. If the server returns a 4xx or 5xx HTTP header (76) an error is generated. If the server returns a ‘file moved’ HTTP header 301/302 (79), the file's address is updated (80) and the process restarted (75). If the server responds with a success HTTP header (78), the file is assigned a unique file name and its contents are retrieved into a temporary storage area (81). The file properties are analyzed to determine the size and file type (82). If the file requires analysis to extract other URL's (84), the file is scanned for URL's (FIG. 17). All file information is returned to the initiating process.

Referring now to FIG. 5, there is shown the FTP file retrieval. When a request for an FTP file is initiated, the file security system (20) first retrieves and decrypts the authentication information for the customer's server (100). An FTP connection object is created (101) and a connection attempt made. If the connection is successfully established (102), the authentication information is correct (103), and the file name is correct and permissions allow it (104), the file assigned a unique filename and retrieved into a temporary storage area (105). The file properties are analyzed to determine the size and file type (106) and the information is returned to the initiating process.

Referring now to FIG. 6, there is shown the file signature process. The first step in file signature generation is to read the file from temporary storage (125) and remove any content inside <WEBGUARD_IGNORE> start and close tags and the tags themselves from the file contents (126). The file is then passed through several one-way hash algorithms (127), currently SHAH-1, MD2 and MD5, and the resulting signatures interspersed with random characters to make them all 50 characters long (128), wherein the random characters can be any alphanumeric or non alphanumeric characters. The digital signatures are combined (129) with the X509 digital certificate of the file security system (20) issued by a trusted third party (132), a periodically changing central password (133), and an X509 digital certificate supplied by the customer or issued by the file security system (20) acting as a Certificate Authority to the customer (134), and a timestamp from a secure time source (135). The resulting data is passed through an MD5 one-way hash algorithm to generate a unique signature for the combined data (130) and the signature is interspersed with random characters to make it 50 characters long (131). Any different one-way hash algorithm known to those skilled in the art could be used for the purpose in keeping within the scope of the invention.

Referring now to FIG. 7, there is shown file storage within the file security system (20). The file storage repository is managed by a separate system that is invoked with the temporary storage location of the file (81, 105), the customer account information and the file URL (150). The file is copied to a temporary working area within the storage system and is assigned a new unique file name (151). A storage file name is generated by encrypting and hashing the file URL with MD5 or an equivalent one-way hash algorithm. (152). The file is then compressed (153) and encrypted (154). A copy is made and the copy is unencrypted and uncompressed and checked against the original copy (155). If the two files match the file is moved to a permanent storage directory and all the temporary files are cleaned up (156).

Referring now to FIG. 8, there is shown a HTTP/HTTPS file scan launcher. The scan process for HTTP and HTTPS files (30) is controlled by a launcher which runs permanently (or every minute) and which controls a configurable number of workers (175). When it starts a scan process the launcher will wait until previous jobs are completed (176) then generate a unique scan id based on the time of the scan (177). The launcher finds the list of HTTP/HTTPS files that are due for scanning by comparing the current scan time to the next scan time recorded in the database for the files (178) then organizes the list by account (179).

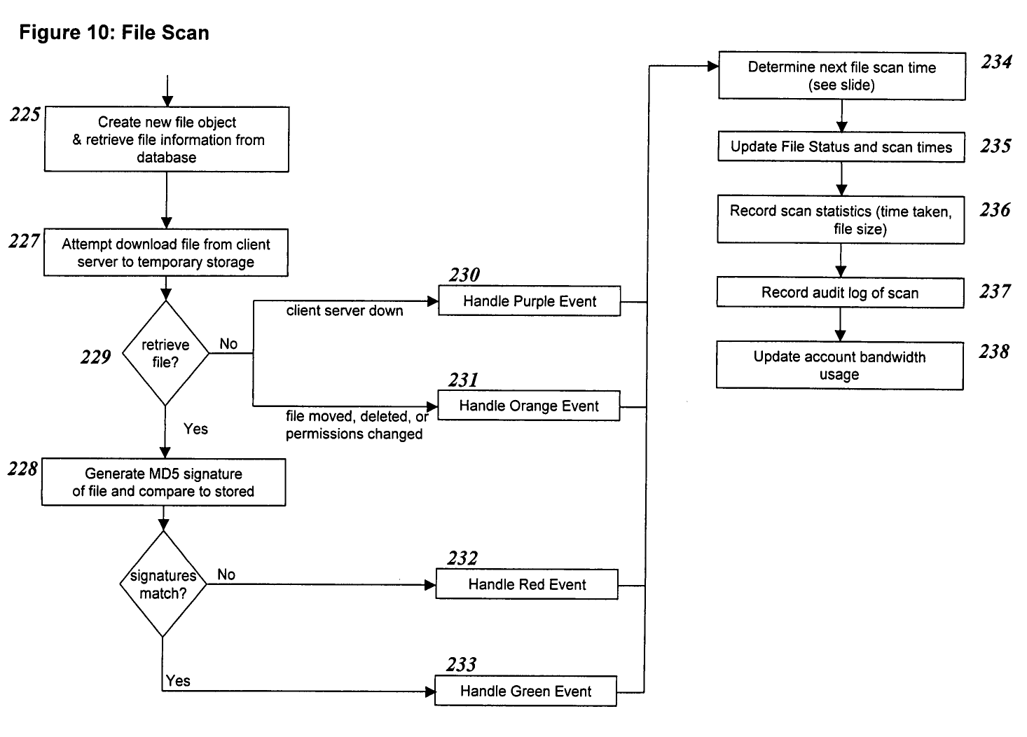

The launcher then enters a loop that continues until there are no files left to process and no workers processing files (180). During the loop, the launcher first checks whether there are any free workers (182), i.e. if the number known to be currently working is less than the number of workers allowed. If there are, the account which has no files being scanned and which has the largest number of files left to scan is calculated (183). If the account has a bandwidth cap, the information for the first file in the account's file list is checked against the account caps (185). If there is sufficient bandwidth left to the account, the scan is launched (FIG. 10). If there is not sufficient bandwidth the customer is notified and the remaining scans for the file are cancelled.

Once all workers are assigned, the launcher loops through the currently active workers (187) and checks to see if they have completed their assigned file scan (188). If the scan is complete the worker is assigned to any files left in the same account (189), the new file information (191) is checked against the account caps (192) and if sufficient bandwidth is left, the scan is launched (193). If there are no files left to scan in the same account, the worker is freed for use in other accounts (190). If there is not sufficient bandwidth the customer is notified and the remaining scans for the file are cancelled. Once there are no accounts without workers left, multiple workers are assigned to the outstanding accounts based on the number of files left to scan. Once there are no remaining files to scan, any pending whole scan alerts are sent out (181).

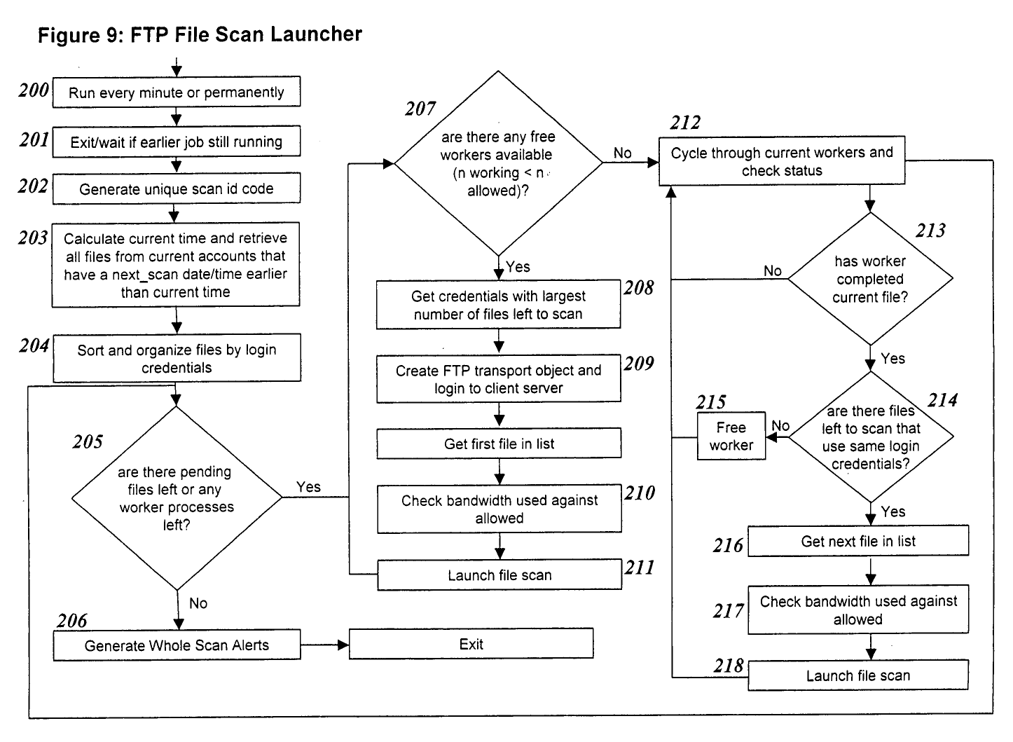

Referring now to FIG. 9, there is shown the FTP file scan launcher. The launcher runs every minute or permanently (200). When it starts a scan process the launcher will wait until previous jobs are completed (201) then generate a unique scan i.d. based on, for example, the time of the scan (202). The current time is calculated and files are retrieved (203). The FTP scan process is thus substantially similar to the HTTP/HTTPS file scan launcher except that files are organized (204) and workers assigned (207-211) by login credentials to a customer's server (204). Workers login to the customer's servers and scan all the necessary files on that server avoiding the time and resources to connect, login and disconnect from a server for each file.

Referring now to FIG. 10, there is shown the file scan of the present invention. When a worker from FIG. 8 or FIG. 9 is launched, the worker initiates a new file object and loads the file information (225). The worker then attempts to retrieve the file from the customer's server (227). If the file cannot be retrieved, the system determines whether the client's server is unavailable (230) which triggers a Server Unavailable/Purple event or it's because the file has moved, been deleted or it's permissions changed such that it is not readable (231), which triggers a File Moved/Deleted/Orange event. If the file is retrievable, the file is downloaded to a temporary storage area and an MD5 signature is generated and compared to the registered with the file security system (20) (228). A different hash algorithm could be used. If the signatures match, a File Unchanged/Green event is triggered for the file (233). If the signatures do not match, a File Changed/Red event is triggered (232). The colors are simple visual substitute for the various file statuses.

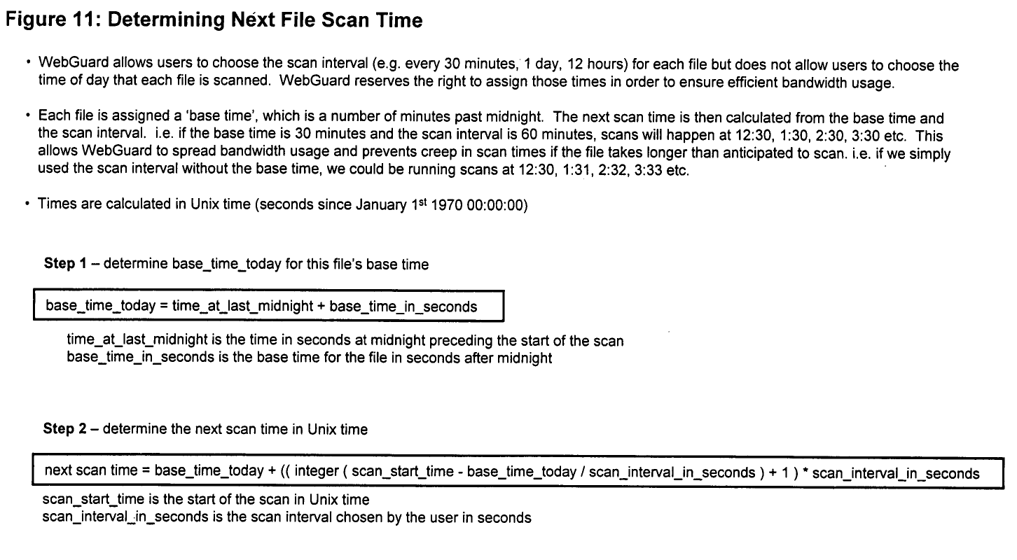

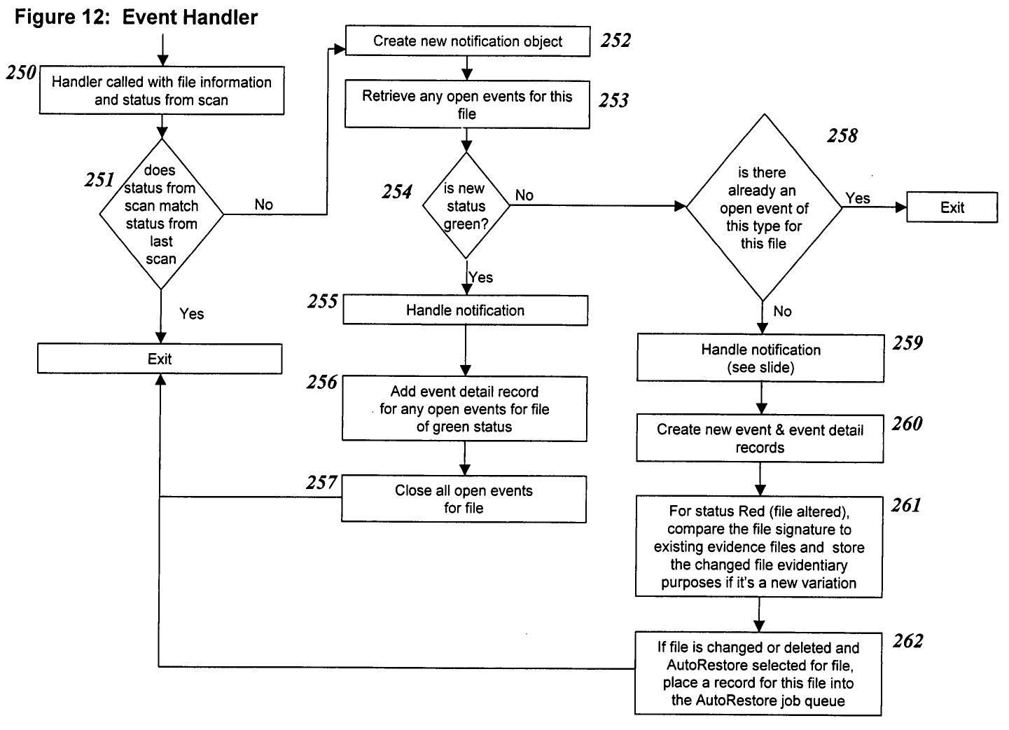

Once the file's status has been determined and handled (FIG. 12) the next scheduled scan time for the file (234) is determined (FIG. 11). The file's new information (235), availability statistics (236) and a log of the scan (237) are recorded in the file security system (20) repositories (15,16,17). The updated monthly bandwidth usage is also updated (238).

Referring now to FIG. 11, there is shown a determination of the next file scan time. The file security system (20) allows users to choose the scan interval (e.g. every 30 minutes, 1 day, 12 hours) for each file but, in one preferred embodiment, does not allow users to choose the time of day that each file is scanned. In such an embodiment the file security system (20) can assign those times in order to ensure efficient bandwidth usage. In order to best spread the bandwidth usage consistently, each file is assigned a ‘base time,’ which is a number of minutes past midnight. The next scan time is then calculated from the base time and the scan interval. i.e. if the base time is 30 minutes and the scan interval is 60 minutes, scans will happen at 12:30, 1:30, 2:30, 3:30 etc. This allows the file security system (20) to spread bandwidth usage and prevents creep in scan times if the file takes longer than included to scan. Without that, the scan times could change with each scan, e.g. 12:30, 1:31, 2:32, 3:33 etc. The base time is determined according to the following formula:
Step 1—determine base_time_today for the file's base time
base_time_today=time_at_last_midnight+base_time_in_seconds
time_at_last_midnight is the time in_seconds at midnight preceding the start of the scan
base_time_in_seconds is the base time for the file in seconds after midnight
Step 2—determine the next scan time in Unix time
next scan time=base_time_today+((integer (scan_start_time−base_time_today/
scan_interval_in_seconds)+1)*scan_interval_in_seconds
scan_start_time is the start of the scan in Unix time
scan_interval_in_seconds is the scan interval chosen by the user in seconds

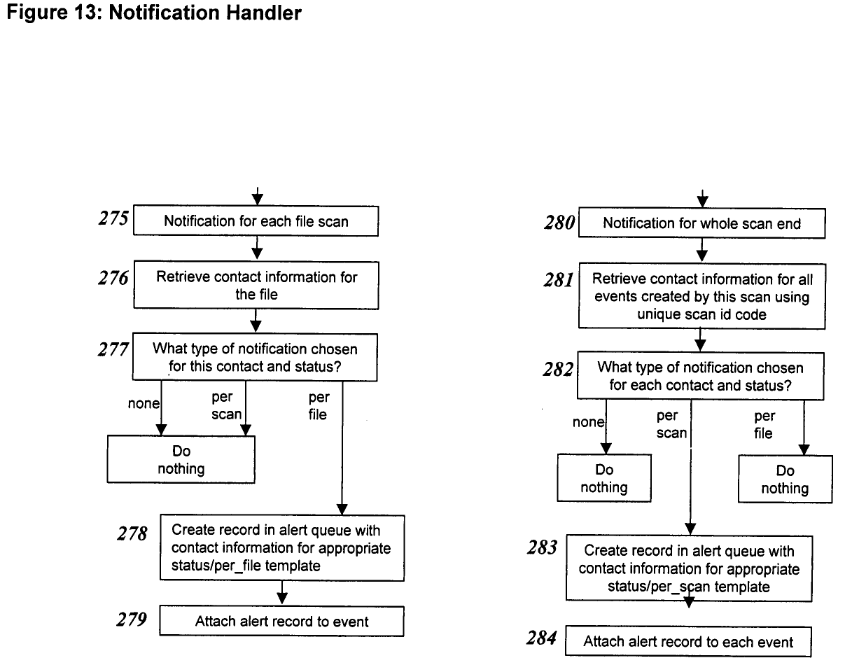

Referring now to FIG. 12, there is shown the event handler. When a file event is started by a file scan (250) the status of the event is compared to the existing file status (251). If the statuses match, no further action is necessary. If the statuses do not match an event object is initiated (252) and the system retrieves any events for the file that are open. If the new status is File Unchanged/Green (254) notification to the user is initiated (255 and FIG. 13), an event detail record with the information from the current scan is added to any open events (256) and all open events are closed (257). If the new status is not Green, the system determines if there is already an open event with the same status (258) and exits if there is. Otherwise, notification to the customer is initiated (259) and a new event and event detail is created (260). For a File Changed/Red status, the new files are stored for evidentiary purposes in the file repository (17) if they are a file not seen before. If the new status is Red or Orange and AutoRestore is selected for the file, an AutoRestore job is placed into the AutoRestore job queue.

Referring now to FIG. 13, there is shown the notification handler. The file security system (20) customers can set up multiple contact methods for their files. For each contact method they can assign different contact information and notification types (notify me once per file, once per scan or not at all) to each alert level (green, red, purple, range) and for AutoRestore. This allows them to get a summary email of all the files that the file security system (20) has detected changes in during a scan, rather than one email per file. When a file is registered, the customer chooses a contact method to assign to that file. The notification handler can be initiated either for a single file (275) or for a complete scan (280). In each case the contact information for the single (276) or multiple (281) files is compared to the type of notification initiated and the status of the file (277, 282). If the status and type match an alert is initiated in the alert queue (278, 283) and the alert attached to the event that initiated the notification (279, 284).

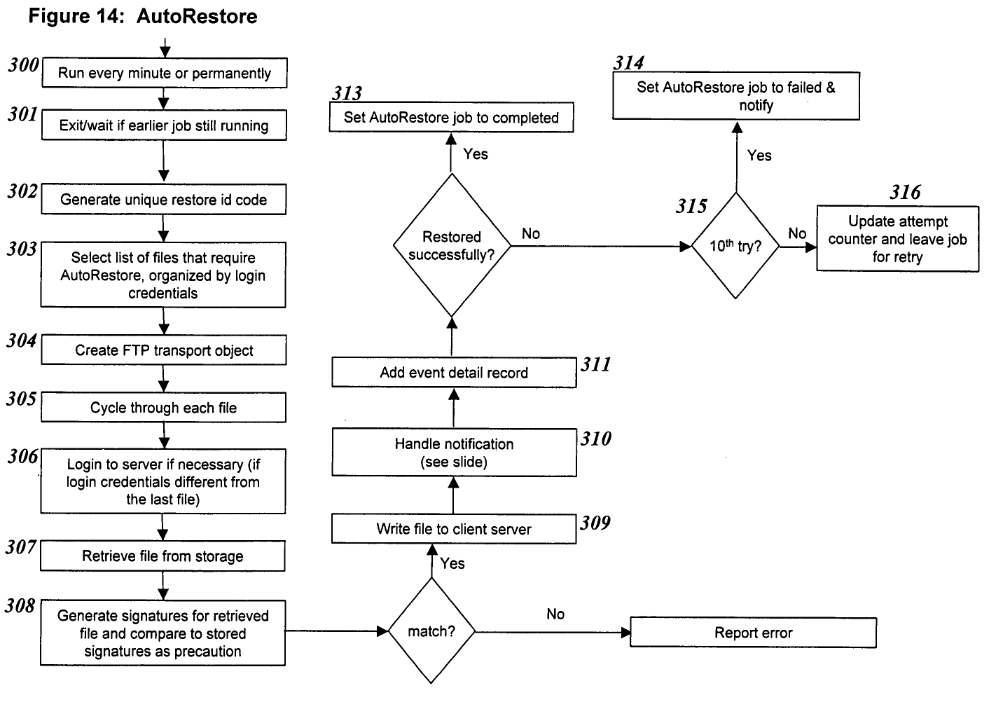

Referring now to FIG. 14, there is shown the AutoRestore. The AutoRestore program runs permanently or is initiated every minute (300) and before every set of jobs is started it checks that there are no AutoRestore processes outstanding (301) and generates a unique AutoRestore id (302). It next selects the pending AutoRestore jobs and organizes them by login credentials (303). A utility FTP connection object is initiated (304). The program then enters a loop which cycles through all the AutoRestore files (305). If the login credentials of the current job do not match the previous job, the program disconnects from the previous server and makes a connection and logs in using the current login credentials (306). The file to be AutoRestored is then retrieved from the file repository (17) to a temporary storage area. The file's signature are generated (127) and compared to the registered ones as a precaution. If the signatures match, the file is transferred to the customer's server (309) overwriting the changed file. Notification is initiated (310) and an event detail record recording the AutoRestore created (311). If the AutoRestore was successful the job is marked as completed (313). If its unsuccessful, the system determines the number of attempts. If it is the 10th failure, the job is marked as failed and the customer notified (34th). Otherwise the attempt is logged and the job left for a later retry (316).

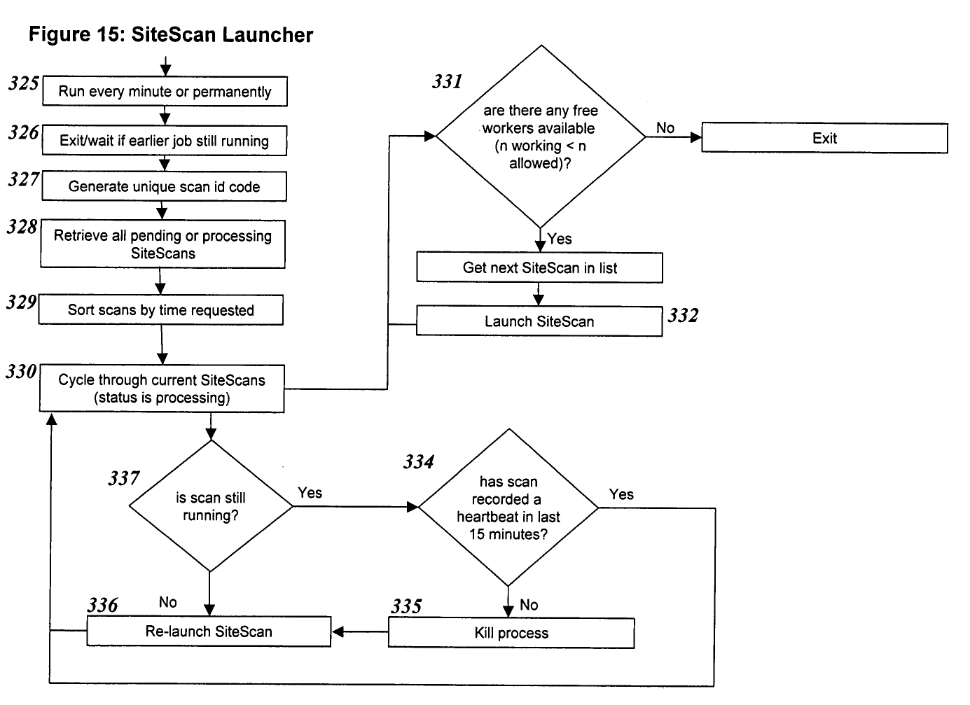

Referring now to FIG. 15, there is shown the SiteScan launcher. The SiteScan launcher runs permanently or is initiated every minute (325), checks that there are no other launcher processes outstanding (326) and generates a unique id (327). It retrieves (328) all pending SiteScan jobs (either manual or on an automated schedule) and organizes them by the scan time (329). The program then loops through all the open SiteScan jobs (330). It determines whether the scan is still running (337) and restarts it if it is not running (336). If a job is still marked as running but has not recorded any activity in over 15 minutes (334), the job is killed (335) and restarted (336). The launcher then determines if there are any available SiteScan workers (331) and launches individual jobs (332) until all workers are used.

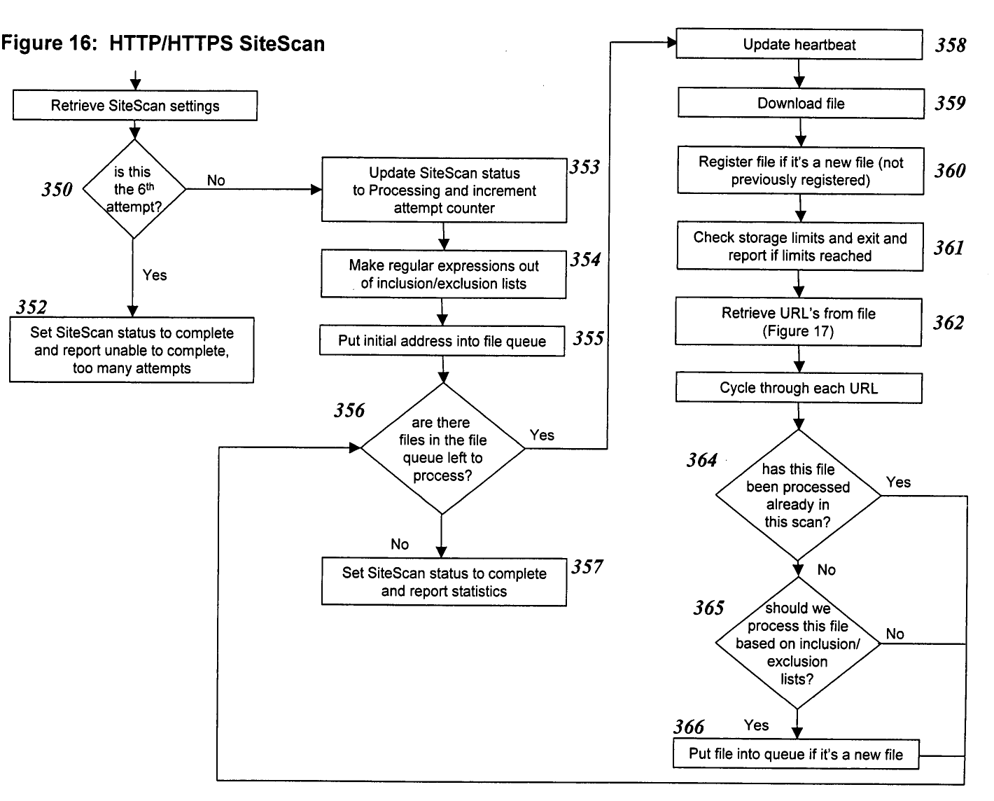

Referring now to FIG. 16, there is shown the HTTP/HTTPS SiteScan. When an individual HTTP or HTTPS SiteScan job is launched, the system first determines whether this is the 6th attempt (350) (or any predetermined number of attempts desired) and if so, completes the scan and records that it failed for too many attempts (352). Otherwise, the job is updated to a processing status and the attempt counter for the job incremented (353). The system next processes (354) the inclusion and exclusion lists into a format for comparison (currently a POSIX standard regular expression). The start address is placed into a queue (355) and the system then loops through the queue until there are no addresses (files) left to process (356), at which point the scan is marked as completed and the scan statistics calculated (357).

If there are files left to process, the heartbeat for the scan job is updated (358), the file is downloaded (359, FIG. 4) and the file registered (FIG. 3) if the file is new to the file security system (20). The account storage limits are checked and the user notified if the limits have been reached (361). If possible, the file is processed (362, FIG. 17) to extract any readable URL's. For every URL that is found, the system determines whether the URL has already been processed in the current scan (364) and if it has not, whether it should be processed based on the inclusion and exclusion lists (365). If the URL is new and falls within the inclusion/exclusion parameters, it is placed into the queue for processing (366).

Referring now to FIG. 17, there is shown an algorithm for processing a file to extract URLs. The process is initiated with a complete set of the file information (375) and first extracts all the standard HTML tags and cycles through them (376) to find the ones that contain URL's (a, img, etc). If a new URL is found (377) and it's filename on the customer's server (378) if possible, the complete (non-relative) URL (379) and file type (380) are determined by comparison to the information for the file being processed.

The system next looks for any URL's outside the standard HTML tags (381) and repeats the analysis (382-385) process. Finally the system looks through all the links and returns the ones that match the list of included sites (386). This prevents the SiteScan from leaving the targeted site and scanning the entire internet.

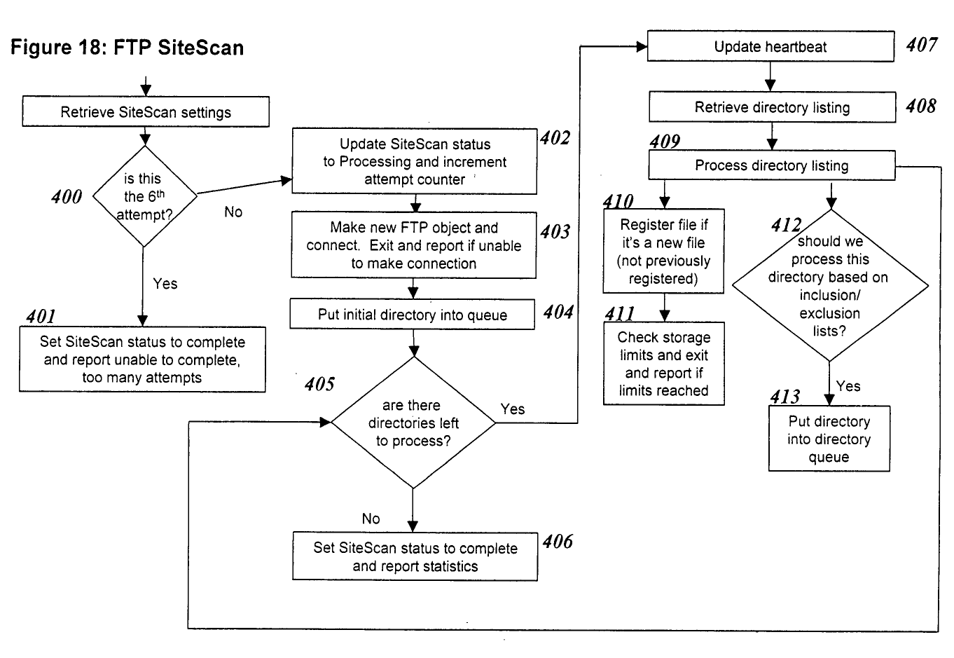

Referring now to FIG. 18, there is shown the FTP SiteScan. The FTP SiteScan is similar to the HTTP/HTTPS SiteScan process (350-353, 357, 358) in it's initiation (400), check for scan attempts (401), update of the scan status and attempt counter (402), scan heartbeat recording (407) and scan completion and statistics calculation (406). The FTP scan process is based on directory scanning. Once the connection is made to the customer's server (403), the first directory is placed into a queue (404) and the program keeps processing the queue until there are no more directories to process (405).

As each directory is processed, the directory listing is retrieved (408) and processed (409). If a new file is found, the file is downloaded (410) and registered (FIG. 3) and the account storage limits checked (411). Each directory is checked against the inclusion/exclusion lists (412) and if it meets the criteria for processing, it is added to the directory queue (413).

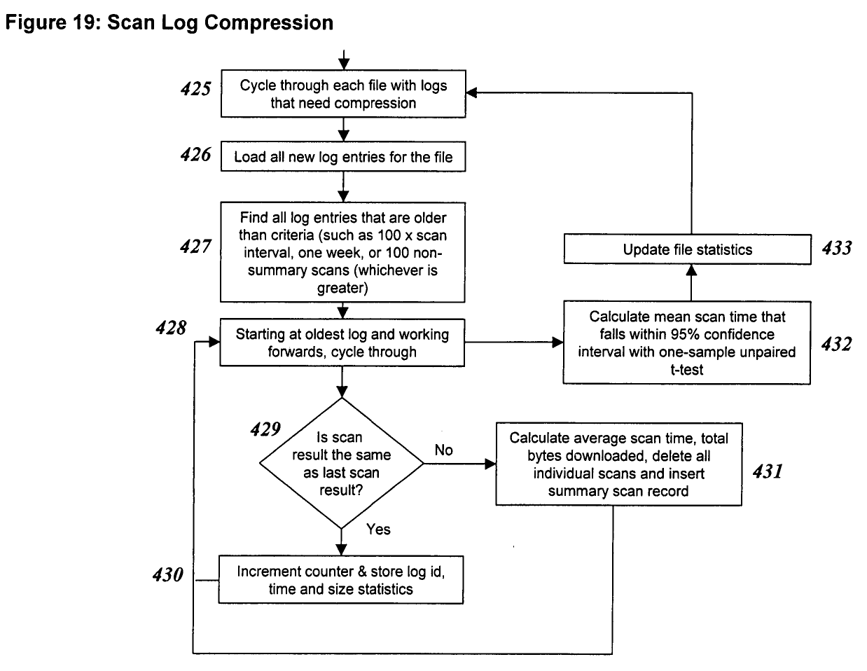

Referring now to FIG. 19, there is shown the scan log compression. The file security system (20) compresses scan logs on a schedule to save space and make them more readable. Complete logs are retained for a certain period of time (or number of logs) and then compressed into a summary format. Instead of, for example, 1000 separate log file entries of an unchanged file, the compression can creates one entry with a count of 1000.

The compression program cycles through all files that have been active since the last compression run (425) and for each file it loads all the log entries until it reaches the end of the file's log entries or until it finds the first summary entry (426). It then determines which of the log entries are eligible for compression (427) based on the file scan interval and the age of the log entry. Starting at the last eligible entry, it cycles forward (428) and compares the status of the file in each log entry to the status of the file in the previous log entry (429). If the status does not change, the program records the log id and keeps a running count of the number of scans, the total time it took to download the file and the number of bytes downloaded (430). If the statuses do not match, the number of scans, average scan time, total bytes downloaded are calculated and recorded as a new summary entry and all the individual log entries are deleted (431). At the end of each file's log entries, the 95% confidence interval for the download time is calculated using an unpaired, one-sample t-test (432) and the file statistics are updated (433).

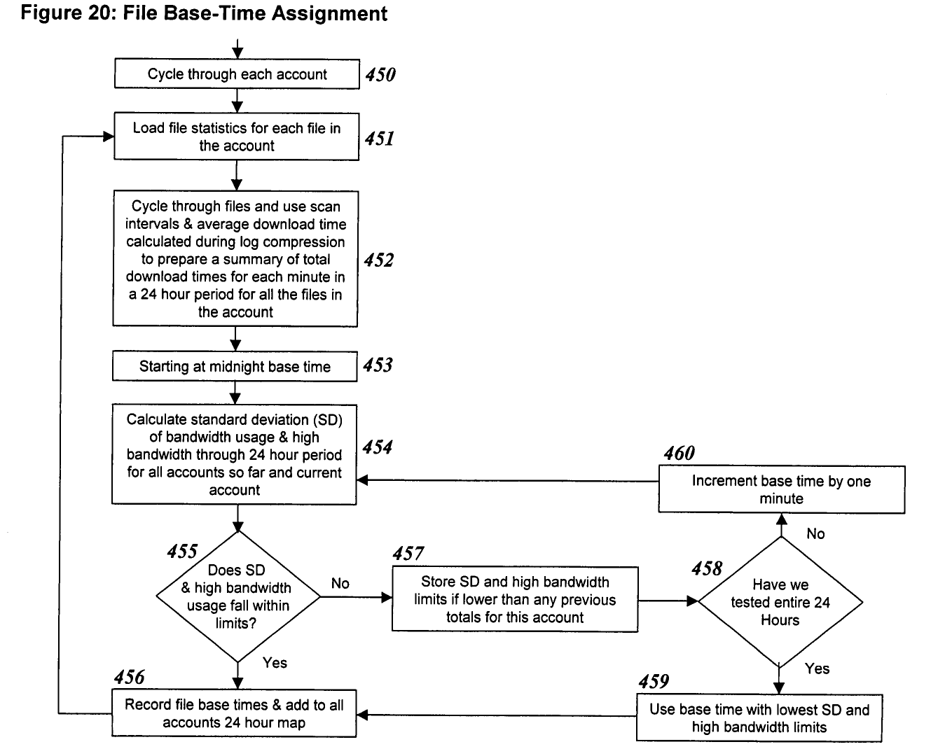

Referring now to FIG. 20, there is shown the file base-time assignment. The file security system (20) assigns base times to files in order to most efficiently utilize bandwidth (FIG. 11) while at the same time trying to group particular accounts files together for communication efficiency. The system cycles through each account (450) and loads the file download statistics for each file in the account (451). From those statistics it prepares a minute-by-minute summary of the amount of information downloaded on a 24 hours basis for the account (452). Then starting at midnight (453) the system combines the account-specific 24 hour summary with summaries from all other accounts worked on so far and calculates the standard deviation and high bandwidth usage for the combined 24 hour summary (454). If these fall within acceptable limits (455), the base time is recorded and the current account summary map added to summary of all accounts (456).

If the standard deviation or bandwidth usage are outside the acceptable parameters, the system cycles through the entire 24 hours clock in one minute increments (460) until a particular base time is found that is within limits. The best standard deviation and lowest high bandwidth limits are tracked (457). If a base-time within limits cannot be found (458), the account files are assigned the base times with the best standard deviation and high bandwidth limits (459).

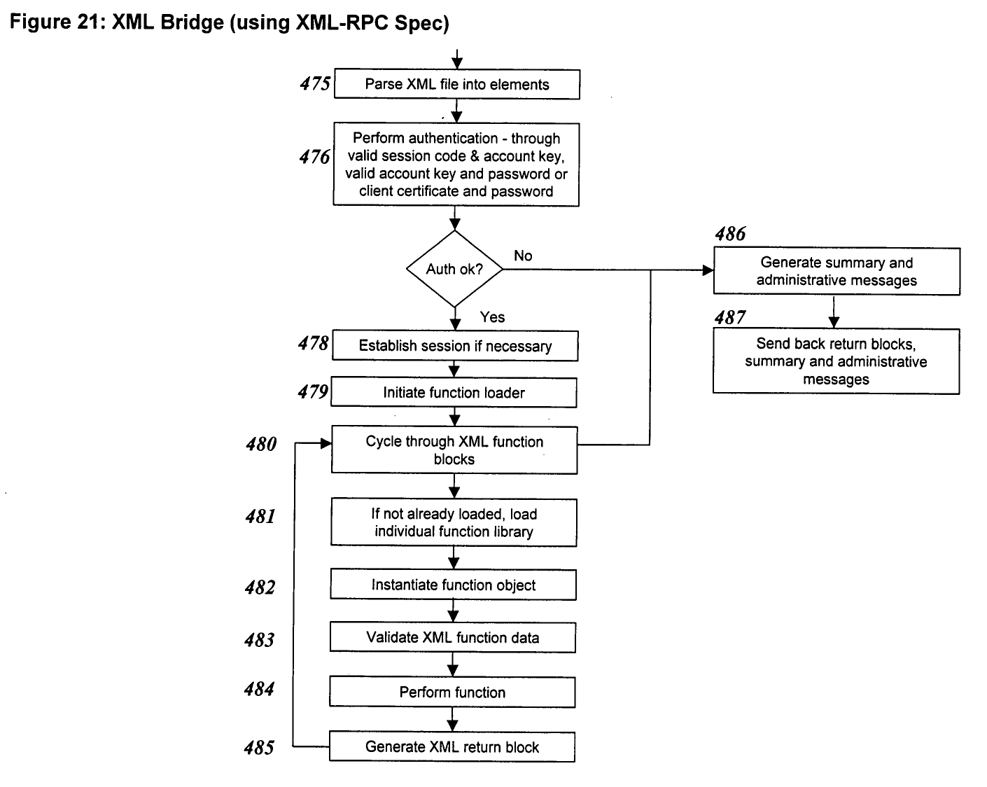

Referring now to FIG. 21, there is shown the XML bridge. The file security system (20) file transactions are passed through a centralized XML transaction bridge or processor using an HTTP or HTTPS communication protocol. The XML bridge supports the XML-RPC spec but support for any other specs known to those skilled in the art is included in the scope of the invention. The XML is decoded into its constituent elements (475) and the XML transaction is authenticated using a combination of a valid session code and account key, a valid account key and password, or a client certificate and password (476). If the authentication fails, an XML return block to that effect is generated. If no session exists, one is established (478) and the main function loader is initiated (479).

Each main XML transaction can contain one or multiple transaction blocks. The system cycles through each block (480) and if necessary loads (481) and initializes (482) the individual block function library. The block XML data is validated (483) and if the validation is passed, the function is performed (484) and an XML return block is created (485). An XML summary of the transactions is generated (486) and combined with any administrative messages and with all the return blocks (487) and sent back.

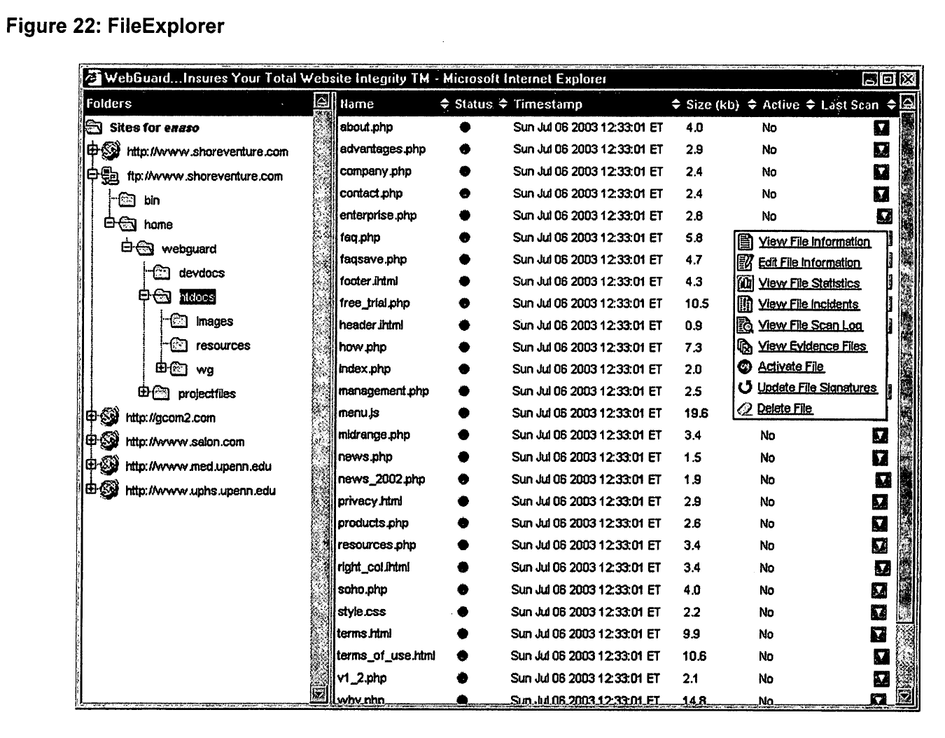

Referring now to FIG. 22, there is shown the file explorer of the present invention. The file explorer is a graphical interface designed to present an online view of an accounts files that is similar to the Windows, Mac or Unix GUI representations of a systems files.

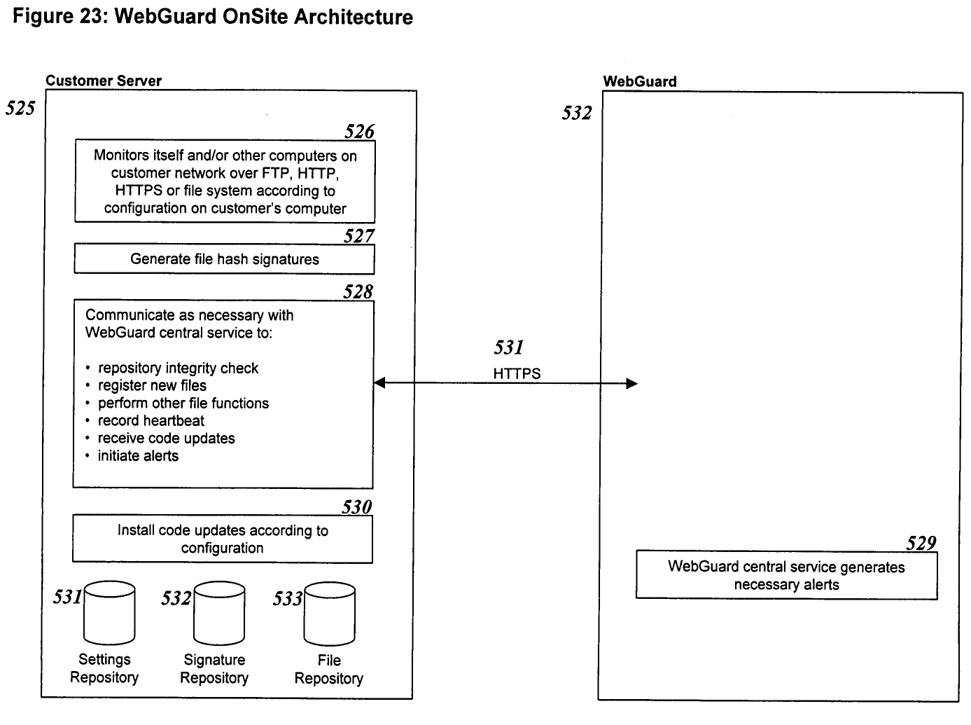

Referring now to FIG. 23, there is shown the file security system (20) OnSite architecture. The file security system (20) OnSite system is designed to offer customers the same level of protection but with much lower bandwidth usage and extra file storage and security options. The file security system (20) OnSite is a software program that is installed as a service or daemon on a customer's computer (525) and which monitors itself or other servers via HTTPIHTTPS, FTP or other file transfer and access protocols (such as NFS, various Windows FS) (526) according to the configuration of the program (527). The Onsite service communicates as necessary with the file security system (20) servers (532, FIG. 1) via XML over HTTPS (531) to register new files and perform other file functions, perform repository integrity checks, record heartbeats and receive updates. Alerts are generated as necessary from the file security system (20) central servers (529). Code updates installation can happen automatically based on the configuration of the OnSite service (530).

The OnSite service maintains a local repository of it's file settings (531), file signatures (532), and, if configured, files (533). Hash codes summaries and statistics of these repositories are periodically checked against the file security system (20) central repositories (15,16,17).

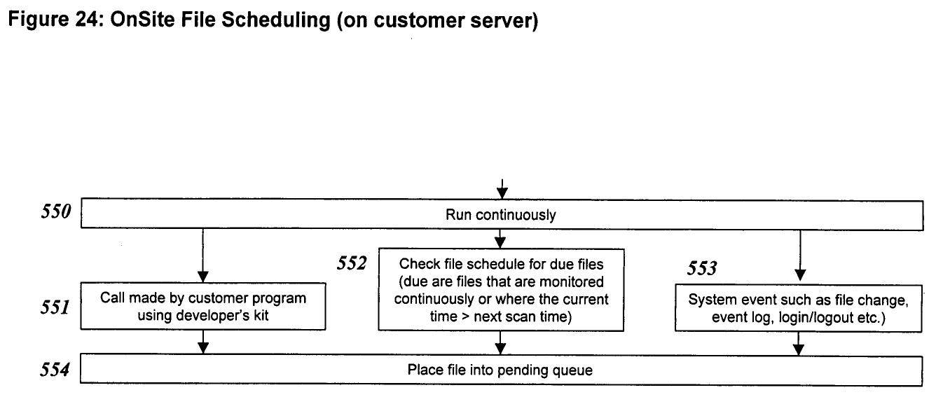

Referring now to FIG. 24, there is shown OnSite file scheduling (can be located on the customer server). The file security system (20) OnSite service runs continuously (550). File scans can be initiated in one of three ways: first a call to the OnSite service can be made by a customer's program using the OnSite SDK (551). Second, files that are monitored continuously or on a schedule can be due for a scan (552). Third, a system event (login, logout, file change) can initiate the scan (553). In all cases, the files to be scanned are placed into a pending queue (554).

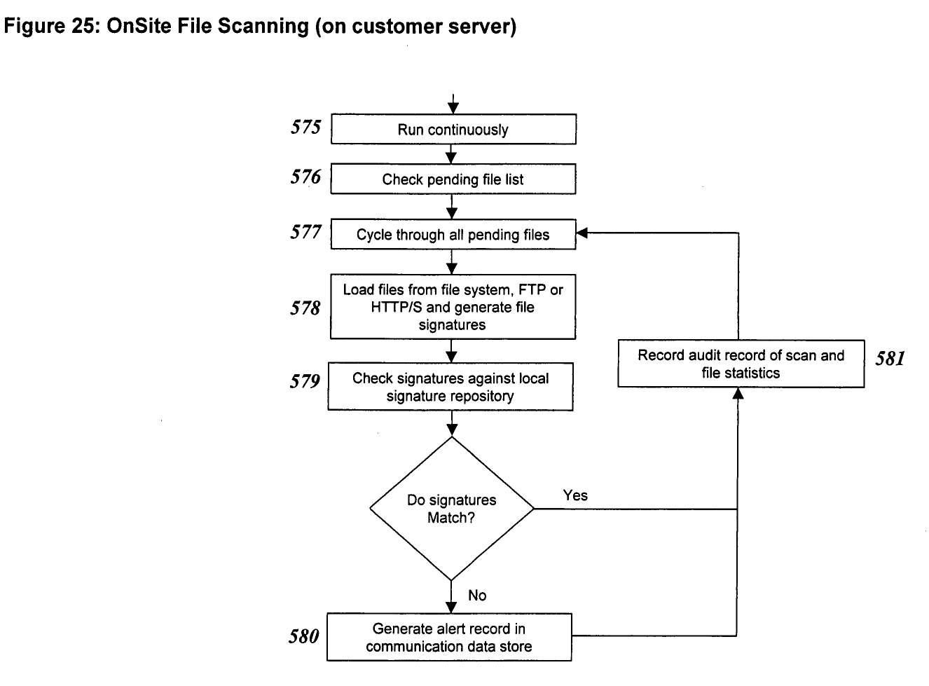

Referring now to FIG. 25, there is shown OnSite file scanning (can be located on the customer server). The OnSite scan service runs continuous (575) and monitors the pending file queue (576). When it finds pending files, it creates the list and cycles through each file (577). The files are loaded using whatever protocol may be necessary, and the file signatures are generated using a one-way hash algorithm (578). The signatures are checked (579) against a local repository of signatures (532). If the signatures do not match, an alert record is placed into the communication queue (580). Finally, an audit record of the scan is generated and the file statistics are updated (581).

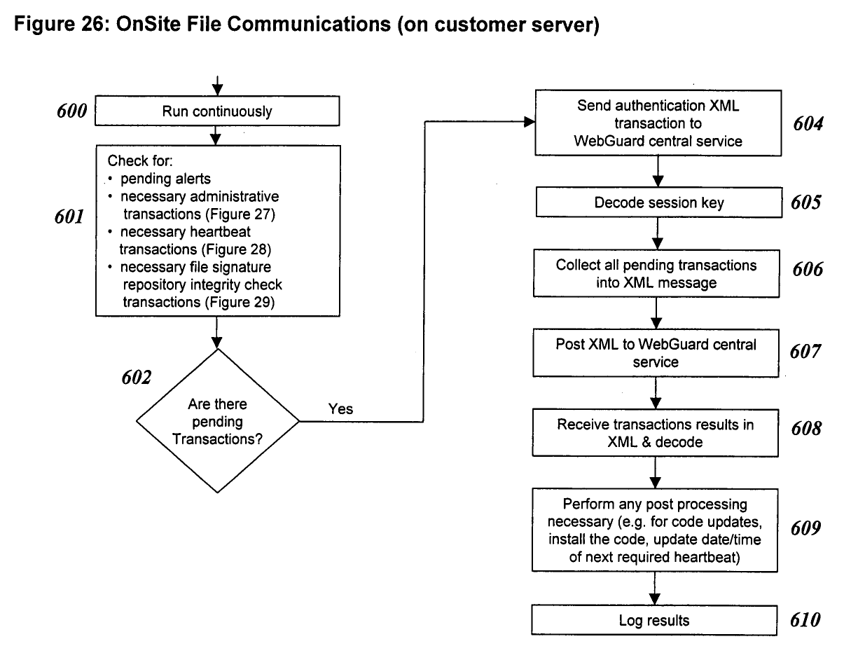

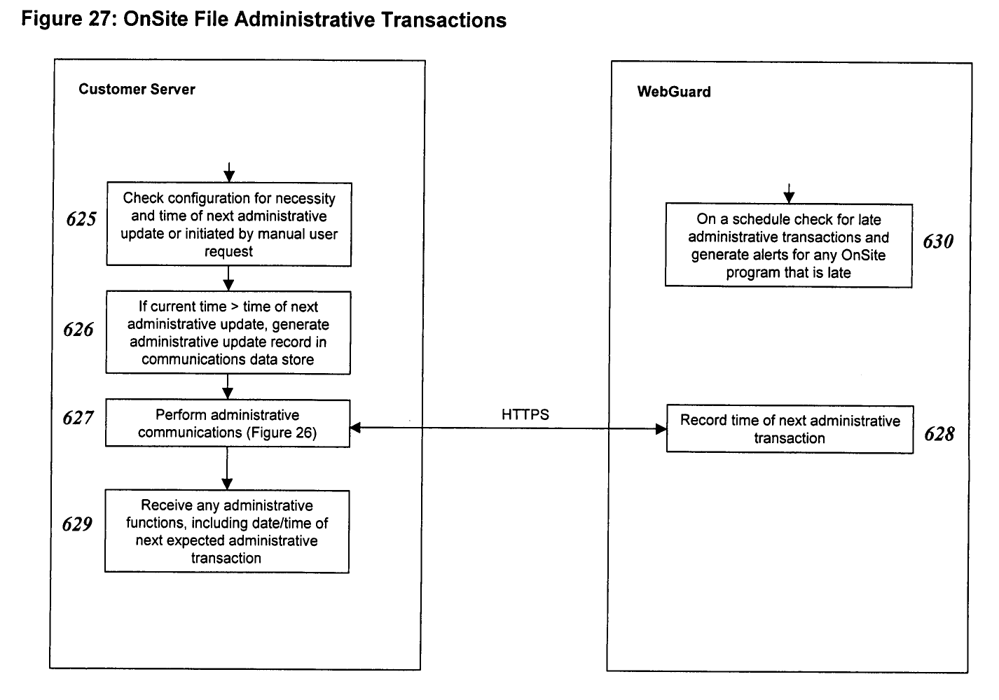

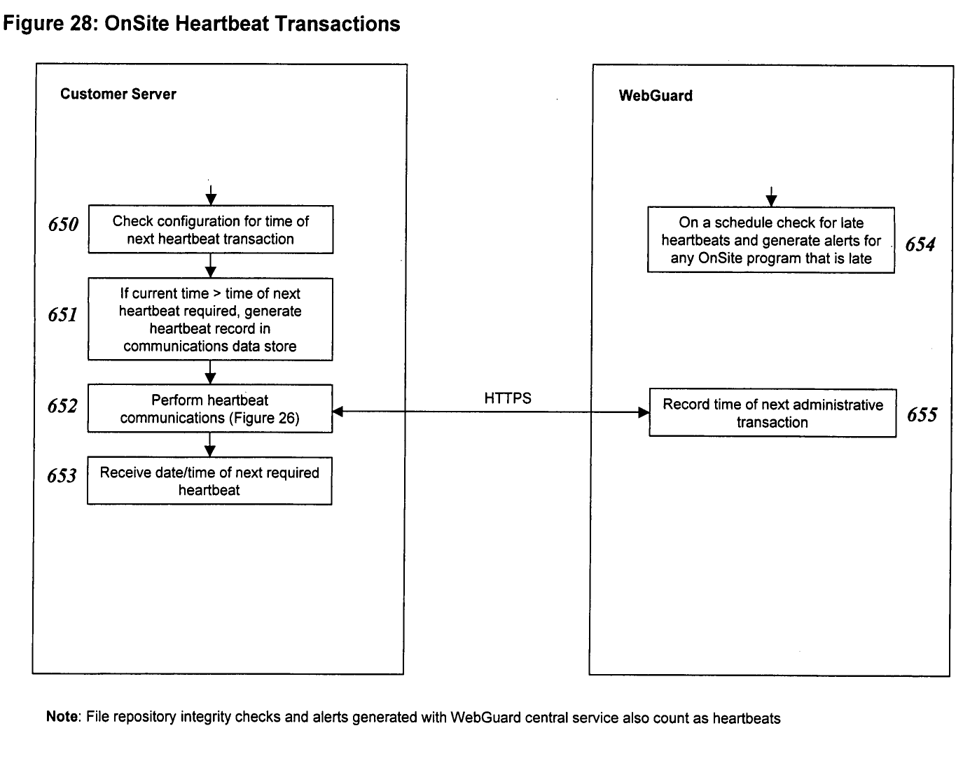

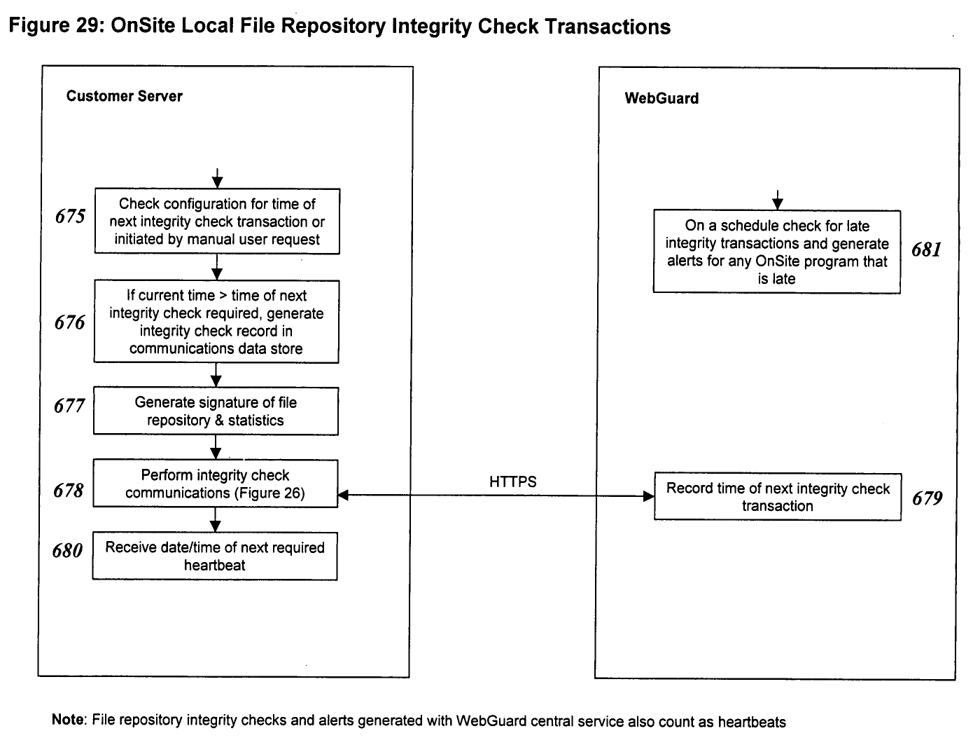

Referring now to FIG. 26, there is shown the OnSite file communications (on customer server). The OnSite communication service runs continuous (600) and monitors the pending communications queue (601) for alerts or administrative (FIG. 27), heartbeat (FIG. 28), or integrity check (FIG. 29) transactions. If there are pending transactions (602), the service initiates an XML transaction (604) with the file security system (20) central service (7, 10). A session key is returned from the central service and decoded (605) using a password stored in both the Onsite service and configured in the file security system (20) administrative interface (8). The communication service next collects information about all the pending communication transactions and generates an XML message compliant with the file security system (20) XML spec (606). The XML message is posted (607) to the file security system (20) central XML Bridge (FIG. 21) and the resulting XML message is received and decoded (608). Any post-processing such as installations or code updates, or settings updates necessary is performed (609) and the results of the transaction are logged (610).

Referring now to FIG. 27, there is shown the OnSite file administrative transactions. Administrative transactions such as code updates and settings exchanges from the file security system (20) OnSite installation are initiated (625) by the communication service (FIG. 26) on the file security system (20) customer server or by manual user request. The service checks the scheduled time of the next administrative update and initiates one if it is due (626). The administrative communications are performed (627) with the file security system (20) central service via XML over HTTPS (FIG. 21). The OnSite service (629) service receives back any post-processing instructions, including the date of the next expected administrative transaction (629), which is also stored in the file security system (20) central service (628). On a schedule the file security system (20) central service checks for any administrative transactions that are overdue and generates alerts to the customers affected (630).

Referring now to FIG. 28, there is shown the OnSite heartbeat transactions. Heartbeat transactions from the file security system (20) OnSite installation are initiated (650) by the communication service (FIG. 26) on the file security system (20) customer server. They are designed to alert the customer should their server fail or the service be stopped. The service checks the scheduled time of the next heartbeat transaction and initiates one if it is due (651). The heartbeat communications are performed (652) with the file security system (20) central service via XML over HTTPS (FIG. 21). The next required heartbeat is recorded by both the OnSite service (654) and the file security system (20) central service (655). On a schedule the file security system (20) central service checks for any heartbeat transactions that are overdue and generates alerts to the customers affected (654).

Referring now to FIG. 29, there is shown the OnSite local file repository integrity check transactions. OnSite repository checks are initiated (675) by the communication service (FIG. 26) on the file security system (20) customer server or by manual user request. The service checks the scheduled time of the next integrity check and initiates one if it is due (676). The OnSite service generates one-way hash signatures of the repositories and calculates statistics such as the number of files being protected and the number of active files (677) and communicates with the file security system (20) central service via XML over HTTPS (FIG. 21). The OnSite service (680) service receives back any post-processing instructions, including the date of the next expected integrity check (679), which is also stored in the file security system (20) central service (680). On a schedule the file security system (20) central service checks for any integrity checks that are overdue and generates alerts to the customers affected (681).

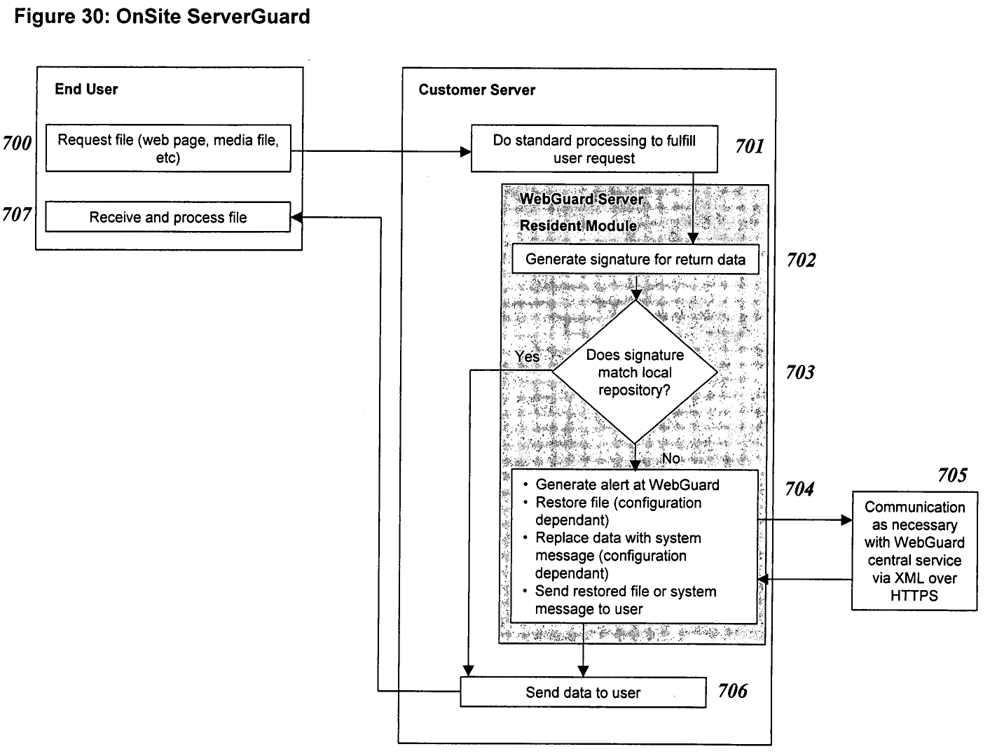

Referring now to FIG. 30, there is shown the OnSite ServerGuard. The ServerGuard is an implementation of the file security system (20) OnSite service that protects data coming from a web server in real time. As a request for a web page (700) is received from an end user of the web site, the web server first performs any standard processing necessary to fulfill the user's request (701). The ServerGuard will have already been installed as a memory-resident module within the web server. The ServerGuard is called to validate the web page before it is returned to the user. The data's signatures are generated (702) and checked (703) against the local repository (532). If the signatures match, the data is sent back to the end user (706) where it is received and processed (707). If they do not, an alert is generated (704) and the file is either restored or replaced with a system message. The file security system (20) central service is alerted (705) and the restored file or system message is returned to the end user (706).

There are multiple methods for a customer to interact manually or automatically with the WebGuard system in order to distinguish genuine, authorized changes to a file from unauthorized changes. The primary current methods are: interaction with the WebGuard administrative website (8), XML transactions via e-mail/SMTP (6) or HTTPS (7) through a mail server (9) or transaction website (10), and e-mail messages sent using a WebGuard keyword system (5). The XML messages can be initiated directly from a manual process, from an automatic system of the customer's design, or from a WebGuard OnSite Agent (FIGS. 23-30) which is in turn responding to a customer's manual or automated request.

The change notification transaction with WebGuard can be initiated prior, at the time of or subsequent to the change. In each case, the full range of methods for interacting with the WebGuard system are available. Prior to the change, the transaction includes a scheduled time for the change, either as an absolute Greenwich Mean Time or as a count of minutes into the future. Subsequent to the actual change, the change notification transaction can be initiated in reply to a WebGuard alert using keywords in the reply.

In performing a change transaction at the scheduled time, or subsequent to an alert, the system first archives the current version of the file and, if supplied, applies a version number to the file. The new version of the file is then registered (FIG. 3) with the WebGuard system and the signatures (FIG. 6) and other file information updated. If no problems are encountered, any open events for the file are closed and the appropriate notifications initiated (FIGS. 12, 13). If the system is unable to register the file (for instance, the file is not readable) the system generates the appropriate alerts.

In the spidering operations performed in accordance with the forgoing method and system, the site scanner determines the complete absolute URL and file system location of a particular file or program by comparing them to the URL and file system location of the initial start point of the scan. The scanner first splits the URL and the file system path (using the appropriate file system directory delineator character) of the start point into a hierarchical list of directories. For each subsequent file found, the scanner repeats the split operations. The scanner then traverses the directory list of the subsequent files backwards until it reaches a common directory with the start point. From that common directory, the scanner can combine the start point's and the individual file's location information into the complete file system location and absolute URL of each file.

While the invention has been described in detail and with reference to specific examples thereof, it will be apparent to one skilled in the art that various changes and modifications can be made therein without departing from the spirit and scope thereof.

1. A method for monitoring a file in a file security system, comprising the steps of:
(a) providing a first file representation of a file wherein said file is disposed at a first location;
(b) first processing said first file representation to provide first signals in accordance with said first file representation;
(c) storing said first signals in a central repository disposed at a second location wherein said second location is remote from said first location;
(d) providing a second file representation of said file wherein said file is disposed at a third location remote from said second location;
(e) second processing said second file representation to provide second signals in accordance with said second file representation;
(f) accessing said first signals from said central repository and comparing said first signals with said second signals; and
(g) determining a status of said file in accordance with said comparing.

2. The method for monitoring a file in a file security system of claim 1, wherein said first location is substantially the same as said third location.

3. The method for monitoring a file in a file security system of claim 1, wherein said first and second processing steps comprise the further step of applying a hash function to said first and second file representations.

4. The method for monitoring a file in a file security system of claim 3, comprising the further step of providing corresponding first and second mathematical signatures of said first and second file representations in accordance with said hash functions.

5. The method for monitoring a file in a file security system of claim 4, comprising the further step of comparing said first and second mathematical signatures.

6. The method for monitoring a file in a file security system of claim 1, comprising the further step of comparing substantially the entireties of said first and second file representations.

7. The method for monitoring a file in a file security system of claim 1, comprising the further step of excluding a selected portion of said first and second file representations from said comparing.

8. The method for monitoring a file in a file security system of claim 1, wherein said file comprises a database.

9. The method for monitoring a file in a file security system of claim 1, wherein said file comprises a combination of files.

10. The method for monitoring a file in a file security system of claim 1, wherein said file comprises the output of a program.

11. The method for monitoring a file in a file security system of claim 1, wherein steps (d)-(g) are repeated periodically.

12. The method for monitoring a file in a file security system of claim 1, wherein steps (d)-(g) are repeated continuously.

13. The method for monitoring a file in a file security system of claim 1, wherein steps d-g, are performed in response to a predetermined system event.

14. The method for monitoring a file in a file security system of claim 1, wherein steps (d)-(g) are manually initiated.

15. The method for monitoring a file in a file security system of claim 1, comprising the further step of providing an alert in response to said determining of said status of said file.

16. The method for monitoring a file in a file security system of claim 1, comprising the further step of restoring said file in response to said determining of said status of said file.

17. The method for monitoring a file in a file security system of claim 1, wherein said file is disposed in a web site comprising the further step of traversing said web site using a spider.

18. The method for monitoring a file in a file security system of claim 17, wherein said web site includes a plurality of web site addresses and said file is provided with a corresponding file physical address comprising the further step of matching a web site address of said plurality of web site addresses with said file physical address.

19. A method for monitoring a file in a file security system, comprising the steps of:
(a) providing a plurality of files disposed at a plurality of differing locations, each file of said plurality of files having a respective location indicator for indicating the location of said plurality of locations where said file is disposed and a respective first file representation;
(b) first processing each first file representation to provide a corresponding plurality of first signals in accordance with said first file representations;
(c) storing said plurality of first signals and said respective location indicators in a central repository disposed in a location remote from said differing locations;
(d) providing a second file representation of a selected file of said plurality of files, said selected file having a selected location indicator;
(e) second processing said second file representation to provide second signals in accordance with said second file representation;
(f) accessing selected first signals of said plurality of first signals from said central repository in accordance with said selected location indicator; and
(g) comparing said selected first signals with said second signals.

20. A method for monitoring a file in a file security system of claim 19, comprising the further step of determining a status of said selected file in accordance with said comparing.

21. The method for monitoring a file in a file security system of claim 19, wherein said first and second processing comprise the further step of applying a hash function to said first and second file representations.

22. The method for monitoring a file in a file security system of claim 21, comprising the further step of providing corresponding first and second mathematical signatures of said first and second file representations in accordance with said hash function.

23. The method for monitoring a file in a file security system of claim 22, comprising the further step of comparing said first and second mathematical signatures.

24. The method for monitoring a file in a file security system of claim 19, comprising the further step of comparing substantially the entireties of said first and second file representations.

25. The method for monitoring a file in a file security system of claim 19, comprising the further step of excluding a selected portion of said first and second file representations from said comparing.

26. The method for monitoring a file in a file security system of claim 19, wherein a file of said plurality of files comprises a database.

27. The method for monitoring a file in a file security system of claim 19, wherein a file of said plurality of files comprises a combination of files.

28. The method for monitoring a file in a file security system of claim 19, wherein a file of said plurality of files comprises the output of a program.

29. The method for monitoring a file in a file security system of claim 19, wherein steps (d)-(g) are repeated periodically.

30. The method for monitoring a file in a file security system of claim 19, wherein steps (d)-(g) are repeated continuously.

31. The method for monitoring a file in a file security system of claim 19, wherein steps (d)-(g) are performed in response to a predetermined system event.

32. The method for monitoring a file in a file security system of claim 19, wherein step d, is manually initiated.

33. The method for monitoring a file in a file security system of claim 20, comprising the further step of providing an alert in response to said determining of said status of said selected file.

34. The method for monitoring a file in a file security system of claim 20, comprising the further step of restoring said selected file in response to said determining of said status of said selected file.

35. The method for monitoring a file in a file security system of claim 19, comprising the further step of determining a first location indicator associated with a first file representation.

36. The method for monitoring a file in a file security system of claim 35, comprising the further step of accessing said selected first signals in accordance with said first location indicator.

37. The method for monitoring a file in a file security system of claim 19, wherein said file is disposed in a web site comprising the further step of traversing said web site using a spider.

38. The method for monitoring a file in a file security system of claim 37, wherein said web site includes a plurality of web site addresses and said file is provided with a corresponding file physical address comprising the further step of matching a web site address of said plurality of web site addresses with said file physical address.

39. A method for monitoring a file in a file security system, comprising the steps of:
(a) providing a file to be monitored;
(b) applying a plurality of hash functions to said file to provide a corresponding plurality of file signatures;
(c) applying a time varying stamp to at least one of said file signatures of said plurality of file signatures to provide a time stamped file signature;
(d) combining said file signatures of said plurality of signatures including said time stamped file signature in order to provide a combined file signature;
(e) applying a hash function to said combined file signature to provide a hashed file signature; and
(f) comparing said hashed file signature with a further file signature.

40. The method for monitoring a web page in a web security system of claim 39, wherein said plurality of hash functions comprises the SHAH-1, MD2 and MD5 hash functions.

41. The method for monitoring a file in a file security system of claim 39, comprising the further of step interspersing said file signatures of said plurality of file signatures with random characters to form a plurality of file signatures having a predetermined length.

42. The method for monitoring a file in a file security system of claim 39, comprising the further step of changing said time varying stamp daily.

43. The method for monitoring a file in a file security system of claim 42, comprising the further step of storing a plurality of said time varying stamps for use in subsequent comparisons of said file signature with differing file signatures.

44. The method for monitoring a file in a file security system of claim 41, comprising the further step of interspersing said combined file signature with random characters to provide a plurality of combined file signature having a predetermined length.

45. The method for monitoring a file in a file security system of claim 44, wherein said plurality of hash functions is applied to a first file representation of said file comprising the further steps of:
(a) providing a second file representation of said file;
(b) applying said plurality of hash functions to said second file representation to provide a corresponding plurality of further file signatures;
(c) combining said further file signatures of said plurality of further file signatures to provide a further combined file signature;
(d) applying a hash function to said further combined file signature to provide a further hashed file signature;
(e) comparing said hashed file signature with said further file signature; and
(f) determining a status of said file in accordance with said comparing; and
(g) applying a hash function to said further combined file signatures to provide a further hashed signature.

46. The method for monitoring a file in a file security system of claim 45, wherein said hashed signature is stored in a central repository disposed at a location remote from said file.

47. The method for monitoring a file in a file security system of claim 39, wherein said hashed signature and said further signature are representative of substantially the entirety of said file.

48. The method for monitoring a file in a file security system of claim 39, wherein said hashed signature and said further signature are representative of a selected portion of said file.

49. The method for monitoring a file in a file security system of claim 39, wherein said file comprises a database.

50. The method for monitoring a file in a file security system of claim 39, wherein said file comprises a combination of files.

51. The method for monitoring a file in a file security system of claim 48, wherein said file comprises the output of a program.

52. The method for monitoring a file in a file security system of claim 45, wherein said second file representation is determined periodically.

53. The method for monitoring a file in a file security system of claim 39, comprising the further step of providing an alert in response to said comparing.

54. The method for monitoring a file in a file security system of claim 39, comprising the further step of restoring said file in response to said comparing.

55. The method for monitoring a file in a file security system of claim 39, wherein said file is disposed in a web site comprising the further step of traversing said web site using a spider.

56. The method for monitoring a file in a file security system of claim 55, wherein said web site includes a plurality of web site addresses and said file is provided with a corresponding file physical address comprising the further step of matching a web site address of said plurality of web site addresses with said file physical address.

57. The method for monitoring a file in a file security system of claim 39, comprising the further step of applying a digital signature to at least one of said file signatures.

58. The method for monitoring a file in a file security system of claim 39, comprising the further step of applying a certificate assigned by said file security system to at least one of said file signatures of said plurality of file signatures.

59. The method for monitoring a file in a file security system of claim 39, comprising the further step of applying a pass phrase to at least one of said file signatures of said plurality of file signatures.

60. The method for monitoring a file in a file security system of claim 39, comprising the further step of applying a time indicating stamp to at least one of said file signatures of said plurality of file signatures.

61. A method for monitoring a file in a file security system, comprising the steps of:
(a) providing a first file representation of a file wherein said file is disposed at a first location;
(b) first processing said first file representation to provide first signals in accordance with said first file representation;
(c) storing said first signals in a central repository disposed at a second location wherein said second location is remote from said first location;
(d) notifying said second location of a change in said file;
(e) altering said first signals in accordance with said notifying to provide altered first signals;
(f) accessing said altered first signals from said central repository; and
(g) determining a status of said file in accordance with said altered first signals.

62. The method for monitoring a file in a file security system if claim 61, comprising the further steps of:
(a) providing a second file representation of said file;
(b) second processing said second file representation to provide second signals in accordance with said second file representation;
(c) comparing said altered first signals with said second signals; and
(d) determining said status of said file in accordance with said comparing.

63. The method for monitoring a file in a file security system of claim 62, comprising the further steps of:
(a) applying a hash function to said first and second file representations;
(b) providing corresponding first and second mathematical signatures of said first and second file representations in accordance with said hash function; and
(c) comparing said first and second mathematical signatures.

64. The method for monitoring a file in a file security system of claim 62, comprising the further step of excluding a selected portion of said first and second file representations from said comparing.

65. The method for monitoring a file in a file security system of claim 61, wherein said file comprises a database.

66. The method for monitoring a file in a file security system of claim 61, wherein said file comprises a combination of files.

67. The method for monitoring a file in a file security system of claim 61, wherein said file comprises the output of a program.

68. The method for monitoring a file in a file security system of claim 62, wherein the step of providing a second file representation of said file is repeated periodically.

69. The method for monitoring a file in a file security system of claim 62, wherein the step of providing a second file representation of said file is repeated continuously.

70. The method for monitoring a file in a file security system of claim 62, wherein the step of providing a second file representation of said file is performed in response to a predetermined system event.

71. The method for monitoring a file in a file security system of claim 62, wherein the step of providing a second file representation of said file is manually initiated.

72. The method for monitoring a file in a file security system of claim 61, comprising the further step of providing an alert in response to said determining of said status of said file.

73. The method for monitoring a file in a file security system of claim 61, comprising the further step of restoring said file in response to said determining of said status of said file.

74. The method for monitoring a file in a file security system of claim 61, wherein said file is disposed in a web site comprising the further step of traversing said web site using a spider.

75. The method for monitoring a file in a file security system of claim 61, wherein said web site includes a plurality of web site addresses and said file is provided with a corresponding file physical address comprising the further step of matching a web site address of said plurality of web site addresses with said file physical address.

76. The method for monitoring a file in a file security system of claim 61, comprising the further step of notifying using HTTP.

77. The method for monitoring a file in a file security system of claim 71, comprising the further step of notifying using XML transactions.

78. The method for monitoring a file in a file security system of claim 76, comprising the further step of notifying using HTTPS.

79. The method for monitoring a file in a file security system of claim 76, comprising the further step of notifying using SMTP.

80. The method for monitoring a file in a file security system of claim 76, comprising the further step of notifying using a transaction website.

81. The method for monitoring a file in a file security system of claim 61, wherein said notifying occurs prior to said change.

82. The method for monitoring a file in a file security system of claim 61, wherein said notifying occurs after said change.

83. The method for monitoring a file in a file security system of claim 61, wherein said notifying occurs simultaneously with said change.

84. The method for monitoring a file in a file security system of claim 61, wherein said change occurs on a scheduled basis.

85. The method for monitoring a file in a file security system of claim 61, comprising the further step of notifying using a pre-agreed protocol over a pre-agreed transport.
